(19) United States
(12) Patent Application Publication
(10) Pub. No.: US 2010/0209136 A1
(43) Pub. Date: Aug. 19, 2010

(54) COATING FLUID FOR ELECTROPHOTOGRAPHIC PHOTORECEPTOR, ELECTROPHOTOGRAPHIC PHOTORECEPTOR, AND ELECTROPHOTOGRAPHIC- PHOTORECEPTOR CARTRIDGE

(75) Inventors: Tadashi Mizushima, Kanagawa (JP); Hiroaki Takamura, Kanagawa (JP); Atsuo Saita, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical Corporation, Minato-ku, Tokyo (JP)

(21) Appl. No.: 12/526,270

(22) PCT Filed: Feb. 6, 2008
(86) PCT No.: PCT/JP2008/051970

§ 371 Date: Apr. 26, 2010

(30) Foreign Application Priority Data
Feb. 7, 2007 (JP) 2007-027526

(51) Int. Cl. G03G 21/16; C08G 64/04; C08G 65/00; G03G 5/04; G03G 15/00

(52) U.S. Cl. 399/111; 528/86; 525/390; 430/56; 399/159

(57) ABSTRACT

Disclosed is a coating liquid for producing an electrophotographic photosensitive body, which is excellent in electrical characteristics and mechanical durability, while being excellent in coatability and liquid stability. Also disclosed are an electrophotographic photosensitive body produced by using such a coating liquid, an image-forming device comprising such an electrophotographic photosensitive body, and an electrophotographic photosensitive body cartridge. Specifically disclosed is a coating liquid for producing an electrophotographic photosensitive body, which is characterized by containing a copolymerized polycarbonate resin and asolvent A having a boiling point of not less than 80#C but not more than 150#C. The copolymerized polycarbonate resin has a repeating unit represented by the formula (1) below, while containing not more than 10% by weight of a repeating unit having a biphenyl structure. The average of repetitions of the unit represented by the formula (1) is not more than 10.

### TECHNICAL FIELD

The present invention relates to an electrophotographic photoreceptor for use in copiers, printers, and the like and a coating fluid for electrophotographic-photoreceptor production.

### BACKGROUND ART

Electrophotography is extensively used in the fields of copiers, various printers, and the like because of its instantaneousness, ability to give high-quality images, etc.

With respect to photoreceptors serving as the core of electrophotography, use is being made of photoreceptors employing an organic photoconductive substance which has advantages such as pollution-free nature, ease of film formation, and ease of production.

Known photoreceptors employing an organic photoconductive material include a so-called dispersion type photoreceptor including photoconductive fine particles dispersed in a binder resin and a multilayer type photoreceptor having superposed layers including a charge-generating layer and a charge-transporting layer. The multilayer type photoreceptor has the following advantages. It can be obtained as a high-sensitivity photoreceptor by using a charge-generating substance having a high efficiency in combination with a charge-transporting substance having a high efficiency. There is a wide choice of materials, and a highly safe photoreceptor is hence obtained. Furthermore, since the photosensitive layer can be easily formed by coating-fluid application, the multilayer type photoreceptor has high productivity and is advantageous also from the standpoint of cost. Because of this, photoreceptors of the multilayer type have come to be mainly used, and are being diligently developed and put to practical use.

An electrophotographic photoreceptor is repeatedly used in an electrophotographic process, i.e., used in cycles each including charging, exposure, development, transfer, cleaning, and erase. The photoreceptor hence receives such various stresses and deteriorates. Examples of such deterioration include the following chemical or electrical deterioration. The ozone, which is highly oxidative, and NOₓ which have generated from a corona charging device cause chemical damage to the photosensitive layer. Carriers are generated by the imagewise-exposure light and erase light and flow through the photosensitive layer to decompose the photosensitive-layer composition. External light also causes the decomposition. Furthermore, there also is another kind of deterioration. Namely, the photoreceptor suffers mechanical deterioration such as the wearing or marring of the photosensitive-layer surface and film peeling which are caused, for example, by sliding friction with the cleaning blade, magnetic brush, etc. and contact with the developer, transfer member, or paper. In particular, such mars which have generated in the surface of the photosensitive layer are apt to appear in images and directly impair image quality. Such mars are hence a strong factor which limits the life of the photoreceptor. Namely, essential requirements for developing a photoreceptor having a long life are to enhance electrical and chemical durability and to simultaneously heighten mechanical strength.

A photosensitive layer is generally constituted of a binder resin and a photoconductive substance. Polycarbonates are frequently used as the binder resin from the standpoints of electrical properties and mechanical durability. Polycarbonate resins have repeating structures which include a repeating structure derived from an aromatic polyhydric alcohol. Especially frequently used are copolycarbonate resins having a repeating structure derived from 2,2-bis(4-hydroxyphenyl)propane. However, this structure has high crystallinity and, hence, these copolycarbonate resins have poor solution stability. There has been a problem that when such a resin is to be used as a solution in a solvent, this solution is apt to gradually crystallize and increase in gel content although uniform in the initial stage immediately after dissolution.

This problem concerning crystallization may be eliminated when a halogenated solvent having one or more halogen atoms in the molecule is used. Although the copolycarbonate resins are soluble in several halogenated solvents, use of these solvents is undesirable from the standpoint of recent environmental preservation. Some copolymers including that disclosed in JP-B-7-27223 are soluble in tetrahydrofuran. However, these copolymers are still insufficient in solution stability.

### DISCLOSURE OF THE INVENTION

### Problems to be Solved by the Invention

The invention has been achieved in order to overcome the problems described above and to obtain a stable coating fluid containing a polycarbonate resin which is less apt to crystallize. Namely, an object of the invention is to provide a coating fluid for electrophotographic-photoreceptor production which is excellent in electrical properties and mechanical durability and also in coating property and fluid stability, an electrophotographic photoreceptor produced with the coating fluid, and an image-forming apparatus and an electrophotographic cartridge each equipped with the electrophotographic photoreceptor.

### Means for Solving the Problems

The present inventors diligently made investigations. As a result, they have found that a coating fluid for electrophotographic-photoreceptor production which is excellent in electrical properties and mechanical durability and poses no problem concerning coating property or fluid stability is obtained by using a specific copolymer resin and a specific solvent. The invention has been thus achieved.

An essential point of the invention resides in a coating fluid for electrophotographic-photoreceptor production, comprising: a copolycarbonate resin which contains a repeating structure represented by the following formula (1) and does not contain a repeating structure having a biphenyl structure in an amount of 10% by weight or larger, in which the average number of repetition of the formula (1) is 10 or smaller; and a solvent A having a boiling point of from 80° C. to 150° C.

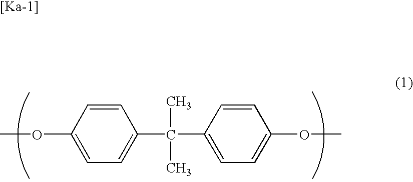

The essential point resides also in a coating fluid for electrophotographic-photoreceptor production, comprising: a copolycarbonate resin which contains a repeating structure represented by the following formula (1) in an amount of 50% by weight or larger, in which the average number of repetition of the formula (1) is 10 or smaller; and a solvent A having a boiling point of from 80° C. to 150° C. Furthermore, the essential point resides also in the coating fluids for electrophotographic-photoreceptor production which further comprises a solvent B having a lower boiling point than the solvent A.

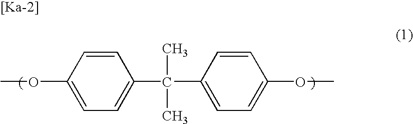

The solvent A preferably is a hydrocarbon compound, and more preferably is an aromatic hydrocarbon compound. It is especially preferred to use toluene.

The copolycarbonate resin preferably is a random copolycarbonate resin, in which constituent units are randomly arranged.

Another essential point of the invention resides in an electrophotographic photoreceptor comprising a photosensitive layer formed by coating the coating fluid according to the invention. It is preferred that the photosensitive layer should contain an aromatic hydrocarbon in an amount, as determined by analysis by gas chromatography, of 0.01 mg/cm³ or larger.

Still another essential point of the invention resides in an image-forming apparatus comprising the electrophotographic photoreceptor, a charging device which charges the electrophotographic photoreceptor, an imagewise-exposure device which imagewise exposes the charged electrophotographic photoreceptor to a light to form an electrostatic latent image, a development device which develops the electrostatic latent image with a toner, and a transfer device which transfers the toner to a receiving object. A further essential point of the invention resides in an electrophotographic cartridge comprising the electrophotographic photoreceptor and at least one of a charging device which charges the electrophotographic photoreceptor, an image wise-exposure device which imagewise exposes the charged electrophotographic photoreceptor to a light to form an electrostatic latent image, a development device which develops the electrostatic latent image with a toner, and a transfer device which transfers the toner to a receiving object.

### ADVANTAGES OF THE INVENTION

According to the invention, a coating fluid for electrophotographic-photoreceptor production can be obtained which is excellent in coating property and fluid stability and gives a photosensitive layer which enables an electrophotographic photoreceptor having this photosensitive layer to be excellent in electrical properties and mechanical durability. Furthermore, an electrophotographic photoreceptor produced with this coating fluid can be obtained according to the invention.

### BRIEF DESCRIPTION OF THE DRAWINGS

FIG. 1 is a diagrammatic view illustrating the constitution of important parts of one embodiment of an image-forming apparatus equipped with the electrophotographic photoreceptor of the invention.

FIG. 2 is an X-ray diffraction pattern of the oxytitanium phthalocyanine used in the Examples according to the invention.

DESCRIPTION OF THE REFERENCE
NUMERALS AND SIGNS

| | |
|---|---|
| 1 | photoreceptor |
| 2 | charging device (charging roller) |
| 3 | exposure device |
| 4 | development device |
| 5 | transfer device |
| 6 | cleaning device |
| 7 | fixing device |
| 41 | developing vessel |
| 42 | agitator |
| 43 | feed roller |
| 44 | developing roller |
| 45 | control member |
| 71 | upper fixing member (pressure roller) |
| 72 | lower fixing member (fixing roller) |
| 73 | heater |
| T | toner |
| P | recording paper (paper, medium) |

### BEST MODE FOR CARRYING OUT THE INVENTION

Best modes for carrying out the invention will be explained below in detail. The invention should not be construed as being limited to the following embodiments, and can be variously modified within the scope of the invention.

The invention relates to: a coating fluid for electrophotographic-photoreceptor production; an electrophotographic photoreceptor having a photosensitive layer formed by applying the coating fluid; an image-forming apparatus employing the electrophotographic photoreceptor; and an electrophotographic cartridge including the electrophotographic photoreceptor.

<Coating Fluid>

The coating fluid of the invention is a solution or dispersion which is to be used for forming the photosensitive layer of an electrophotographic photoreceptor and which contains a specific polycarbonate resin and a specific solvent.

The copolycarbonate resin according to the invention has the repeating structure represented by formula (1) according to the invention. In general, polycarbonate resins having the repeating structure represented by formula (1) are apt to crystallize and there is a possibility that coating fluids obtained by mixing these resins with a solvent might gel with the lapse of time. According to the invention, however, this problem has been unexpectedly eliminated by employing a polycarbonate resin which is a copolymer including the repeating structure represented by formula (1) and a repeating structure different from that repeating structure and by mixing this copolycarbonate resin with a solvent A having a boiling point of from 80° C. to 150° C.

In the case where the photosensitive layer of an electrophotographic photoreceptor which is to be formed using the coating fluid of the invention is a multilayer type photoreceptor which will be explained later, the coating fluid is used mainly for forming a charge-transporting layer. In this case, the coating fluid contains the polycarbonate resin, a solvent, and a charge-transporting material and optionally further contains an antioxidant, leveling agent, and other additives. In the case where the photosensitive layer of an electrophotographic photoreceptor is of the single-layer type which will be explained later, use is generally made of a charge-generating material and an electron-transporting agent besides the ingredients for the coating fluid for forming a charge-transporting layer. By applying these coating fluids, an electrophotographic photoreceptor can be produced.

The coating fluid of the invention can be prepared by merely mixing the specific solvent according to the invention, the specific polycarbonate resin according to the invention, and various materials necessary for the photosensitive layer of an electrophotographic photoreceptor. The sequence of material mixing is not particularly limited. However, from the standpoint of the stability of the coating fluid, it is preferred to conduct heating after material mixing. In the case where the solvent is heated while keeping the vessel open to the atmosphere, the temperature at which the solvent is heated is preferably in the range of from 40° C. to a temperature lower by at least 10° C. than the boiling point of the compound lowest in boiling point of the compounds contained in the solvent. In producing the coating fluid, the vessel may be kept closed. In this case, all raw materials for constituting the coating fluid are charged into a closable vessel and the contents are heated to 30° C.-100° C. and held at that temperature for 1-10 hours with stirring/mixing, whereby the coating fluid can be produced.

<Solvent>

The coating fluid of the invention contains a solvent A having a boiling point of from 80° C. to 150° C. Any solvent which has a boiling point of from 80° C. to 150° C. and is liquid when the coating fluid is used can be employed as the solvent A. More specifically, the solvent is a substance which has a boiling point of from 80° C. to 150° C. and is liquid under the conditions of an atmospheric pressure of 101.3 kPa and a temperature of 25° C.

In the invention, the boiling point of a solvent is defined as the temperature at which the vapor pressure of this compound is equal to the external pressure which is 101.3 kPa. Usually, the boiling point means that value of boiling point for the solvent which is given in Kagaku Binran Kisohen Kaitei 4-han (published by Maruzen Co., Ltd. on Sep. 30, 1993). With respect to any solvent which is not given in that book, the boiling point thereof is defined as the 50% running temperature as determined by the method provided for in JIS K5601-2-3.

In case where a solvent having a boiling point lower than 80° C. is used, the photoreceptor is rapidly cooled by the heat of vaporization of the solvent and suffers blushing due to moisture absorption. In case where a solvent having a boiling point exceeding 150° C. is used, coating-fluid application results in enhanced sagging and hence in an increased amount of unusable parts. Consequently, the boiling point of the solvent A is preferably 80° C. or higher, more preferably 90° C. or higher, most preferably 100° C. or higher, and is preferably 150° C. or lower, more preferably 140° C. or lower, most preferably 130° C. or lower.

A mixed solvent can be used in the coating fluid of the invention so long as the mixed solvent contains at least one solvent A according to the invention. In the case of a mixed solvent, the term “boiling point of a solvent” as used in the invention means not the boiling point of the solvents in the mixture state but each of the boiling points of the individual solvents separated from one another.

In the case where the solvent is a composition, there are no particular limitations on the proportions of the components. The proportion by weight of the solvent A having a boiling point of from 80° C. to 150° C. to all solvents is generally 1% by weight or higher, preferably 5% by weight or higher, more preferably 10% by weight or higher, and is generally 80% by weight or lower, preferably 50% by weight or lower, more preferably 30% by weight or lower. In the case where the solvent having a boiling point of from 80° C. to 150° C. is used as a solvent mixture with one or more other solvents, that solvent is generally used in combination with a solvent B having a lower boiling point. In this case, too low proportions by weight of the solvent A having a boiling point of from 80° C. to 150° C. result in rapid cooling of the photoreceptor due to the heat of solvent vaporization after application and hence in blushing due to moisture absorption. On the other hand, too high proportions thereof result in enhanced sagging during application and hence in an increased amount of unusable parts.

In the case where the solvent A is used as a mixed solvent, the solvent B to be used in combination with the solvent A preferably is a solvent having a lower boiling point than the solvent A. Examples of the solvent B include cyclic ethers such as tetrahydrofuran and 2-methyltetrahydrofuran, halogen compounds such as methylene chloride and chloroform, and esters such as methyl acetate and ethyl acetate. However, it is preferred to use the solvent A in combination with a cyclic ether such as tetrahydrofuran or 2-methyltetrahydrofuran among those.

When environmental burden is taken into account, it is preferred that the solvent A to be used in the coating fluid of the invention should be a hydrocarbon compound having no atoms other than carbon and hydrogen atoms (i.e., having no heteroatoms). Preferred of such compounds from the standpoints of coating property and electrical properties are aromatic hydrocarbon compounds having one or more aromatic rings in the molecular structure.

There are no limitations also on the molecular structure of the compound to be used as the solvent A. However, a compound having 6-15 carbon atoms is generally used, and a compound having 7-10 carbon atoms is preferred. Neither too small nor too large numbers of carbon atoms attain the desired boiling point. Furthermore, in the case where the compound to be used as the solvent A has one or more aromatic rings in the molecule, the number of such rings is preferably 1-2, more preferably 1. Neither too small nor too large numbers of rings attain the desired boiling point.

Examples of the solvent A which are usable in the coating fluid of the invention include:

aromatic hydrocarbon compounds such as toluene, o-xylene, m-xylene, and p-xylene;
alicyclic hydrocarbon compounds such as cyclohexane and methylcyclohexane;
aliphatic hydrocarbon compounds such as n-heptane;
chain alcohols such as isopropyl alcohol, 1-propanol, 1-butanol, s-butyl alcohol, and t-butyl alcohol;
aromatic alcohols such as o-cresol, m-cresol, and p-cresol; ketones such as methyl ethyl ketone, methyl isobutyl ketone, cyclohexanone, and diacetone alcohol;
esters such as butyl acetate, methoxyethyl acetate, amyl acetate, n-propyl acetate, isopropyl acetate, and methyl lactate;
cyclic ethers such as 1,4-dioxane;
halogenated hydrocarbons such as trichloroethylene, perchloroethylene, and chlorobenzene; and cyclic esters such as γ-butyrolactone.

Of these, hydrocarbon compounds having a cyclic structure, such as toluene, o-xylene, m-xylene, p-xylene, cyclohexane, and methylcyclohexane, are preferred from the standpoints of satisfactory coating property and reduced influence on the environment. More preferred are aromatic hydrocarbon compounds such as toluene, o-xylene, m-xylene, and p-xylene. Especially preferred of these is toluene.

Of the compounds enumerated above, 1,4-dioxane has hitherto been sometimes used as a coating solvent. However, use of 1,4-dioxane is undesirable because it imposes a heavy burden on the environment and health, as designated in various laws.

<Copolymer Resin>

The coating fluid of the invention contains a copolymer resin having the repeating structure represented by the following formula (1).

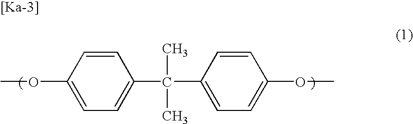

The copolymer resin in the invention is a copolycarbonate resin which contains the repeating structure represented by formula (1) and further contains at least one kind of repeating structure differing from the repeating structure represented by formula (1). Especially preferred of such copolycarbonates is the random copolycarbonate resin which will be described later.

The copolycarbonate resin according to the invention can be produced by known production processes conducted under optimized conditions. In one example of the known processes, an aqueous alkali solution, pyridine, or the like is added as an acid acceptor to phenol compounds (e.g., bisphenol A) in the presence of an inert solvent, such as methylene chloride or 1, 2-dichloroethane, and phosgene is continuously introduced and reacted with the phenol compounds.

When an aqueous alkali solution is used as an acid acceptor, an increased reaction rate is obtained by using as a catalyst a tertiary amine such as trimethylamine or triethylamine or a quaternary ammonium compound such as tetrabutylammonium chloride or benzyltributylammoniumbromide.

According to need, a monohydric phenol such as phenol or p-tert-butylphenol may be caused to coexist as a molecular-weight regulator. With respect to catalyst introduction, any desired method can be used. For example, the catalyst may be added from the beginning. Alternatively, the catalyst may be introduced after oligomer formation to heighten the molecular weight thereof.

Examples of methods for copolymerizing two or more phenol compounds include:

(a) a method in which the two or more phenol compounds are simultaneously reacted with phosgene from the beginning and copolymerized;
(b) a method in which one of the phenol compounds is first reacted with phosgene to some degree and the other is then introduced and polymerized; and
(c) a method in which the phenol compounds are separately reacted with phosgene to produce oligomers and these oligomers are reacted and polymerized.

For producing a polycarbonate resin, method (c) is frequently used. A bisphenol monomer is first polymerized to obtain an oligomer having degrees of polymerization ranging from 1 to several tens, and this oligomer is further polymerized to thereby produce a desired polycarbonate resin. When a copolymer is to be synthesized, it can be produced by polymerizing two oligomers. According to this production process, a sequence (block) of the same bisphenol units is formed at the point of time when each oligomer has been synthesized. Such a copolymer is called a block copolymer.

The copolycarbonate resin according to the invention has the property of being apt to crystallize because it has the repeating structure represented by formula (1) according to the invention. In the case where the repeating structure represented by formula (1) according to the invention is present as such a block structure constituted of repetitions of the repeating structure, this copolycarbonate resin is more apt to crystallize. It is therefore preferred that the amount of such block structures should be smaller. Namely, a copolycarbonate resin which is reduced in the amount of block structures constituted of the repeating structure represented by formula (1) according to the invention and which has the so-called random structure is preferred.

The term “random copolycarbonate resin” means a resin in which the repeating units constituting the resin have been randomly arranged. Usually, it is a copolycarbonate resin in which the average number of repetitions of the same repeating unit is 10 or smaller, preferably 5 or smaller. In the copolycarbonate resin according to the invention, the average number of repetitions of the repeating structure represented by formula (1) is 10 or smaller, preferably 5 or smaller, more preferably 4 or smaller. The copolycarbonate resin to be sued in the invention may be a resin produced by any process, so long as this resin satisfies the requirements described above.

The average number of repetitions in the invention can be determined by calculation from ratios between signals obtained by ¹H-NMR spectroscopy. This is explained below using an example. In a polycarbonate having the following structural formula (2), the left-side repeating structure and the right-side repeating structure in the formula are expressed by A and C, respectively.

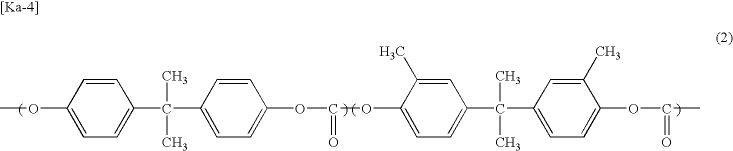

When the proportions of the respective repeating structures are expressed by [A] and [C], then the values of [A] and [C] can be determined using the following equations.

[A]/[C]=X (X can be determined from signal ratio obtained by ¹H-NMR spectroscopy)

[A]+[C]=1

Next, when the proportions of two united repeating units are expressed by [AA], [AC], and [CC], then the following equations hold.

[A]=[AA]+[AC]/2

[C]=[CC]+[AC]/2

[AA]+[AC]+[CC]=1

[AC]/[CC]=Y (Y can be determined from signal ratio obtained by ¹H-NMR spectroscopy)

By solving these equations, proportions can be determined as shown below.

[AA]=(2+Y−2(1+Y)[C])/(2+Y)

[AC]=2Y[C]/(2+Y)

[CC]=2[C]/(2+Y)

The average numbers of repetitions of A and C are defined as shown below using values obtained above.

Average number of repetitions of A: [A]/([AC]/2)

Average number of repetitions of C: [C]/([AC]/2)

The copolycarbonate resin to be used in the invention may be a polycarbonate resin containing either two kinds of repeating structures or three or more kinds of repeating structures so long as it contains the repeating structure represented by formula (1). In this case also, the average numbers of repetitions can be determined by the same method.

A difference in coating-fluid stability between a block copolymer and a random copolymer becomes more significant as the amount of the repeating structure represented by formula (1) according to the invention increases. In the case of a random copolymer, to regulate the amount of the repeating structure represented by formula (1) to 5% by weight or larger based on the whole resin is effective in improving coating-fluid stability. This effect is higher when the amount of the repeating structure is 10% by weight or larger, and is even higher when the amount thereof is 50% by weight or larger. That effect is significantly high when the amount of the repeating structure is 60% by weight or higher, and is especially high when the amount thereof is 70% by weight or higher.

However, too large amounts of formula (1) unavoidably result in gelation even when the copolymer is random. Consequently, the amount thereof is preferably 90% by weight or smaller, more preferably 85% by weight or smaller.

Another process for producing a polycarbonate resin is method (a), in which monomers are mixed in an initial stage to initiate oligomerization. It has become obvious that when a copolymer is produced by this method, units of each bisphenol are more randomly arranged.

Molecular-weight regulation in producing a copolymer resin such as that to be used in the invention has been more difficult than in the production of a polycarbonate homopolymer. Molecular weight is controlled by changing the amount of a monophenol to be added as a chain terminator. In the case of copolymer production, however, polycarbonate copolymers differing in molecular weight from batch to batch are frequently obtained because two or more aromatic diols are used and this results in a difference in terminal-group reactivity.

This problem can be overcome, for example, by the following methods. It has become obvious that when the reaction is conducted in a flow type reaction system such as the pipe reactor shown in JP-A-2007-126493 to produce an oligomer, then this oligomer has a controlled molecular weight and random arrangement. Since this method is free from the lot-to-lot fluctuations in batch production, even oligomers can be obtained and, as a result, molecular-weight fluctuations of a copolymer are reduced. Furthermore, a process in which an alkaline aqueous solution of at least two aromatic diols selected from aromatic diols is reacted with phosgene in the presence of an organic solvent to produce a polycarbonate copolymer may be conducted in the following manner. (a) A carbonate oligomer in which the proportion of the concentration of terminal chloroformate groups to the concentration of OH groups is 1.5 or higher is used as a starting material; (b) a catalyst-containing aqueous alkali solution having an alkali concentration of 0.5-3.0 N and cooled to 10° C. or lower is added en bloc to a solution of the oligomer with stirring; and (c) condensation polymerization reaction is then conducted under temperature conditions of 15° C. or lower. This process enables stable production substantially free from molecular-weight fluctuations. The polycarbonate copolymer thus obtained can be used as the resin according to the invention.

An explanation is then given on other repeating structures usable as a second component of the copolymer together with the repeating structure represented by formula (1) according to the invention.

Other repeating structures usable as a component of the copolycarbonate according to the invention are not particularly limited so long as they are repeating structures different from the repeating structure represented by formula (1). Examples thereof include repeating structures derived from dihydric phenolic compounds. Examples of the dihydric phenolic compounds include the following.

Bifunctional phenol compounds such as hydroquinone, resorcinol, 1,3-dihydroxynaphthalene, 1,4-dihydroxynaphthalene, 1,5-dihydroxynaphthalene, 1,8-dihydroxynaphthalene, 2,3-dihydroxynaphthalene, 2,6-dihydroxynaphthalene, and 2,7-dihydroxynaphthalene; biphenol compounds such as 4,4′-biphenol, 3,3′-dimethyl-4,4′-dihydroxy-1,1′-biphenyl, 3,3′-di(t-butyl)-4,4′-dihdyroxy-1,1′-biphenyl, 3,3′,5,5′-tetramethyl-4,4′-dihdyroxy-1,1′-biphenyl, 3,3′,5,5′-tetra(t-butyl)-4,4′-dihdyroxy-1,1′-biphenyl, 2,2′,3,3′,5,5′-hexamethyl-4,4′-dihdyroxy-1,1′-biphenyl, 2,4′-biphenol, 3,3′-dimethyl-2,4′-dihydroxy-1,1′-biphenyl, 3,3′-di(t-butyl)-2,4′-dihydroxy-1,1′-biphenyl, 2,2′-biphenol, 3,3′-dimethyl-2,2′-dihydroxy-1,1′-biphenyl, and 3,3′-di(t-butyl)-2,2′-dihydroxy-1,1′-biphenyl;

bisphenol compounds having no substituents on the aromatic rings, such as bis(4-hydroxyphenyl)methane,
1,1-bis(4-hydroxyphenyl)ethane,
1,1-bis(4-hydroxyphenyl)propane,
2,2-bis(4-hydroxyphenyl)propane,
1,1-bis(4-hydroxyphenyl)butane,
2,2-bis(4-hydroxyphenyl)butane,
1,1-bis(4-hydroxyphenyl)pentane,
2,2-bis(4-hydroxyphenyl)pentane,
3,3-bis(4-hydroxyphenyl)pentane,
2,2-bis(4-hydroxyphenyl)-3-methylbutane,
1,1-bis(4-hydroxyphenyl)hexane,
2,2-bis(4-hydroxyphenyl)hexane,
3,3-bis(4-hydroxyphenyl)hexane,
2,2-bis(4-hydroxyphenyl)-4-methylpentane,
1,1-bis(4-hydroxyphenyl)cyclopentene, and
1,1-bis(4-hydroxyphenyl)cyclohexane;
   bisphenol compounds having one or more aryl groups as substituents on the aromatic rings, such as
bis(3-phenyl-4-hydroxyphenyl)methane,
1,1-bis(3-phenyl-4-hydroxyphenyl)ethane,
1,1-bis(3-phenyl-4-hydroxyphenyl)propane, and
2,2-bis(3-phenyl-4-hydroxyphenyl)propane; and
bis(4-hydroxy-3-methylphenyl)methane,
1,1-bis(4-hydroxy-3-methylphenyl)ethane,
1,1-bis(4-hydroxy-3-methylphenyl)propane,
2,2-bis(4-hydroxy-3-methylphenyl)propane, and
1,1-bis(4-hydroxy-3-methylphenyl)cyclohexane.
Bis(4-hydroxy-3-ethylphenyl)methane,
1,1-bis(4-hydroxy-3-ethylphenyl)ethane,
1,1-bis(4-hydroxy-3-ethylphenyl)propane,
2,2-bis(4-hydroxy-3-ethylphenyl)propane, and
1,1-bis(4-hydroxy-3-ethylphenyl)cyclohexane.
   Bisphenol compounds having one or more alkyl groups as substituents on the aromatic rings, such as
2,2-bis(4-hydroxy-3-isopropylphenyl)propane,
2,2-bis(4-hydroxy-3-(sec-butyl)phenyl)propane,
bis(4-hydroxy-3,5-dimethylphenyl)methane,
1,1-bis(4-hydroxy-3,5-dimethylphenyl)ethane,
2,2-bis(4-hydroxy-3,5-dimethylphenyl)propane,
1,1-bis(4-hydroxy-3,5-dimethylphenyl)cyclohexane,
bis(4-hydroxy-3,6-dimethylphenyl)methane,
1,1-bis(4-hydroxy-3,6-dimethylphenyl)ethane,
2,2-bis(4-hydroxy-3,6-dimethylphenyl)propane,
bis(4-hydroxy-2,3,5-trimethylphenyl)methane,
1,1-bis(4-hydroxy-2,3,5-trimethylphenyl)ethane,
2,2-bis(4-hydroxy-2,3,5-trimethylphenyl)propane,
bis(4-hydroxy-2,3,5-trimethylphenyl)phenylmethane,
1,1-bis(4-hydroxy-2,3,5-trimethylphenyl)phenylethane, and
1,1-bis(4-hydroxy-2,3,5-trimethylphenyl)cyclohexane;
   bisphenol compounds in which the divalent group connecting the aromatic rings has one or more aryl groups as substituents, such as bis(4-hydroxyphenyl)(phenyl)methane,
1,1-bis(4-hydroxyphenyl)-1-phenylethane,
1,1-bis(4-hydroxyphenyl)-1-phenylpropane,
bis(4-hydroxyphenyl)(diphenyl)methane, and
bis(4-hydroxyphenyl)(dibenzyl)methane;
   bisphenol compounds constituted of aromatic rings connected with an ether bond, such as 4,4′-dihydroxydiphenyl ether and 3,3′,5,5′-tetramethyl-4,4′-dihydroxydiphenyl ether;
   bisphenol compounds constituted of aromatic rings connected with a sulfone bond, such as 4,4′-dihydroxydiphenyl sulfone and 3,3′,5,5′-tetramethyl-4,4′-dihydroxydiphenyl sulfone;
   bisphenol compounds constituted of aromatic rings connected with a sulfide bond, such as 4,4′-dihydroxydiphenyl sulfide and 3,3′,5,5′-tetramethyl-4,4′-dihydroxydiphenyl sulfide; and
(2-hydroxyphenyl)(4-hydroxyphenyl)methane,
1-(2-hydroxyphenyl)-1-(4-hydroxyphenyl)ethane,
2-(2-hydroxyphenyl)-2-(4-hydroxyphenyl)propane,
(2-hydroxyphenyl)(4-hydroxy-3-methylphenyl)methane,
1-(2-hydroxyphenyl)-1-(4-hydroxy-3-methylphenyl)ethane,
2-(2-hydroxyphenyl)-2-(4-hydroxy-3-methylphenyl)propane,
bis(2-hydroxyphenyl)methane, 1,1-bis(2-hydroxyphenyl)ethane,
2,2-bis(2-hydroxyphenyl)propane,
bis(2-hydroxy-5-methylphenyl)methane, and
bis(2-hydroxy-3-methylphenyl)methane.
1,1-Bis(2-hydroxy-4-methylphenyl)ethane,
bis(2-hydroxy-3,5-dimethylphenol)methane,
bis(2-hydroxy-3,6-dimethylphenol)methane,
2,2-bis(2-hydroxy-3,5-dimethylphenol)propane,
bis(4-hydroxyphenyl)ketone, bis(4-hydroxyphenyl)ether,
bis(4-hydroxy-3-methylphenyl)ether, and phenolphthalein.

Preferred of these dihydric phenolic compounds are bisphenol compounds. For example, the preferred compounds include bis(4-hydroxyphenyl)methane,
1,1-bis(4-hydroxyphenyl)ethane,
2,2-bis(4-hydroxyphenyl)propane,
1,1-bis(4-hydroxyphenyl)cyclohexane,
1,1-bis(4-hydroxyphenyl)-1-phenylethane,
bis(4-hydroxy-3-methylphenyl)methane,
1,1-bis(4-hydroxy-3-methylphenyl)ethane,
2,2-bis(4-hydroxy-3-methylphenyl)propane,
1,1-bis(4-hydroxy-3-methylphenyl)cyclohexane,
bis(4-hydroxy-3-ethylphenyl)methane,
1,1-bis(4-hydroxy-3-ethylphenyl)ethane,
2,2-bis(4-hydroxy-3-ethylphenyl)propane,
1,1-bis(4-hydroxy-3-ethylphenyl)cyclohexane,
2,2-bis(4-hydroxy-3-isopropylphenyl)propane,
bis(4-hydroxy-3,5-dimethylphenyl)methane,
1,1-bis(4-hydroxy-3,5-dimethylphenyl)ethane,
2,2-bis(4-hydroxy-3,5-dimethylphenyl)propane,
1,1-bis(4-hydroxy-3,5-dimethylphenyl)cyclohexane;
(2-hydroxyphenyl)(4-hydroxyphenyl)methane,
1-(2-hydroxyphenyl)-1-(4-hydroxyphenyl)ethane,
(2-hydroxyphenyl)(4-hydroxy-3-methylphenyl)methane,
1-(2-hydroxyphenyl)-1-(4-hydroxy-3-methylphenyl)ethane,
bis(2-hydroxyphenyl)methane, 1,1-bis(2-hydroxyphenyl)ethane,
bis(2-hydroxy-5-methylphenyl)methane,
bis(2-hydroxy-3-methylphenyl)methane,
1,1-bis(2-hydroxy-4-methylphenyl)ethane,
bis(2-hydroxy-3,5-dimethylphenyl)methane,
bis(2-hydroxy-3,6-dimethylphenyl)methane,
bis(4-hydroxyphenyl)ketone, bis(4-hydroxyphenyl)ether, and
bis(4-hydroxy-3-methylphenyl)ether.

Especially preferred of these, from the standpoint of ease of the production of dihydric phenolic compounds, are bis(4-hydroxyphenyl)methane, 1,1-bis(4-hydroxyphenyl)ethane, 2,2-bis(4-hydroxyphenyl)propane, 1,1-bis(4-hydroxyphenyl)cyclohexane, 1,1-bis(4-hydroxyphenyl)-1-phenylethane, bis(4-hydroxy-3-methylphenyl)methane, 1,1-bis(4-hydroxy-3-methylphenyl)ethane, 2,2-bis(4-hydroxy-3-methylphenyl)propane, 1,1-bis(4-hydroxy-3-methylphenyl)cyclohexane, bis(4-hydroxy-3,5-dimethylphenyl)methane, 1,1-bis(4-hydroxy-3,5-dimethylphenyl)ethane, 2,2-bis(4-hydroxy-3,5-dimethylphenyl)propane, 1,1-bis(4-hydroxy-3,5-dimethylphenyl)cyclohexane, (2-hydroxyphenyl)(4-hydroxyphenyl)methane, 1-(2-hydroxyphenyl)-1-(4-hydroxyphenyl)ethane, (2-hydroxyphenyl)(4-hydroxy-3-methylphenyl)methane, 1-(2-hydroxyphenyl)-1-(4-hydroxy-3-methylphenyl)ethane, bis(2-hydroxyphenyl)methane, 1,1-bis(2-hydroxyphenyl)ethane, bis(2-hydroxy-3-methylphenyl)methane, 1,1-bis(2-hydroxy-4-methylphenyl)ethane, bis(4-hydroxyphenyl)ketone, bis(4-hydroxyphenyl)ether, and bis(4-hydroxy-3-methylphenyl)ether. A combination of two or more of these dihydric phenolic compounds may also be used.

Preferred other repeating structures derived from the dihydric phenolic compounds are repeating structures represented by the following formula (5).

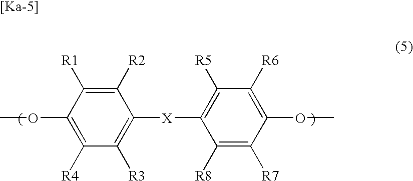

In formula (5), R1 to R8 each independently preferably are hydrogen, an alkyl group, an aryl group, or a halogen, and especially preferably are hydrogen or an alkyl group. When any of R1 to R8 is an alkyl group, it preferably is one having 1-3 carbon atoms, in particular, methyl. In formula (5), X is one member selected from the group consisting of a single bond, a divalent alkylene group which may have one or more substituents, a divalent aryl group, an ether bond, a sulfone bond, and a sulfide bond. Of these, a divalent alkylene group which may have one or more substituents is preferred as X. Especially preferred is one represented by the following formula (6).

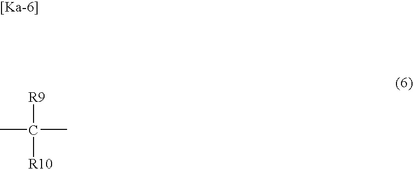

In formula (6), R9 and R10 may be bonded to each other to form a ring or may be independent. When R9 and R10 form a ring, the total number of carbon atoms of R9 and R10 is preferably 10 or smaller, more preferably 7 or smaller, even more preferably 5 or smaller. When R9 and R10 are independent of each other, they each have preferably 3 or less carbon atoms, more preferably one carbon atom. Although R9 and R10 may be the same or different, they preferably are the same. Incidentally, the repeating structures represented by formula (5) are different from the repeating structure represented by formula (1).

The copolymer resin according to the invention contains the repeating structure represented by formula (1) and other repeating structure(s) differing from the repeating structure represented by formula (1). From the standpoint of electrical properties, the content of the repeating structure represented by formula (1) in the resin is as follows. In the case where the copolymer resin is the copolycarbonate resin according to the first aspect, the content of the repeating structure represented by formula (1) in the resin is preferably 30% by weight or higher, more preferably 50% by weight or higher, especially preferably 60% by weight or higher, most preferably 70% by weight or higher. In the copolycarbonate resin according to the second aspect, the content thereof is 50% by weight or higher, preferably 60% by weight or higher, more preferably 70% by weight or higher.

The content of each repeating structure in the copolymer resin according to the invention can be determined, for example, by calculation from found values obtained by nuclear magnetic resonance spectroscopy and from the molecular weight determined from the structural formula.

Repeating structures having a biphenyl structure have poor solubility and cause polymerization reaction to be less apt to proceed. Because of this, when such a repeating structure is used in the copolymer in the invention, it is preferred to limit the amount thereof. The amount of the repeating structure having a biphenyl structure which can be contained in the copolymer resin in the invention is preferably smaller than 10% by weight, more preferably smaller than 5% by weight, even more preferably smaller than 1% by weight, most preferably substantially zero. The term “repeating structure having a biphenyl structure” herein means a dihydric-phenol residue having a biphenyl structure as a partial structure. On the other hand, the copolycarbonate resin in the invention can further contain repeating structures other than those described above so long as this does not lessen the effects of the invention.

Examples of the phosgene and/or phosgene derivative to be used in producing the polycarbonate resin for use in this embodiment include carbonate precursors such as phosgene, trichloromethyl chloroformate, oxalyl chloride, and diaryl carbonates, e.g., diphenyl carbonate, di-p-tolyl carbonate, phenyl p-tolyl carbonate, di-p-chlorophenyl carbonate, and dinaphthyl carbonate.

<Electrophotographic Photoreceptor>

The electrophotographic photoreceptor of the invention is explained below. The electrophotographic photoreceptor of the invention has a conductive base and a photosensitive layer formed from the coating fluid of the invention.

<Photosensitive Layer>

The coating fluid of the invention, which is for use in forming the photosensitive layer of an electrophotographic photoreceptor, is a solution or dispersion containing a polycarbonate resin and a solvent.

In the case of a multilayer type photoreceptor, the coating fluid of the invention is used mainly as a coating fluid for forming a charge-transporting layer. This coating fluid contains a polycarbonate resin, solvent, and charge-transporting material and optionally further contains an antioxidant, leveling agent, and other additives. In the case of the single-layer type, a charge-generating material and an electron-transporting agent are generally used besides the ingredients for the coating fluid for forming a charge-transporting layer. By applying these coating fluids, an electrophotographic photoreceptor can be produced.

<Conductive Base>

As the conductive base is mainly used, for example, a metallic material such as aluminum, an aluminum alloy, stainless steel, copper, or nickel, a resinous material to which electrical conductivity has been imparted by adding a conductive powder such as, e.g., a metal, carbon, or tin oxide, or a resin, glass, paper, or the like which has a surface coated with a conductive material, e.g., aluminum, nickel, or ITO (indium-tin oxide), by vapor deposition or coating fluid application. With respect to shape, a conductive base in a drum, sheet, belt, or another form may be used. Use may also be made of a metallic conductive base coated with a conductive material having an appropriate resistance value for the purpose of regulating conductivity, surface properties, etc., or of covering defects.

In the case where a metallic material such as, e.g., an aluminum alloy is employed as a conductive support, it may be used after having been subjected to an anodization treatment, chemical conversion coating treatment, or the like. It is desirable that when an anodization treatment is performed, the base should be then subjected to a pore-filling treatment by a known method.

The surface of the base may be smooth or may have been roughened by a special cutting technique or abrading treatment. Alternatively, the conductive base may be one having a roughened surface obtained by incorporating particles having an appropriate particle diameter into the material constituting the conductive base.

<Undercoat Layer>

An undercoat layer may be disposed between the conductive base and the photosensitive layer in order to improve adhesion, blocking properties, etc. Although the electrophotographic photoreceptor according to the invention has a photosensitive layer formed over the conductive base, it may have an undercoat layer. The undercoat layer according to the invention is disposed between the conductive base and the photosensitive layer, and has at least one of the following and other functions: to improve adhesion between the conductive base and the photosensitive layer; to hide soils, mars, or the like of the conductive base; to prevent carrier injection from occurring due to an impurity or uneven surface properties; to reduce unevenness of electrical properties; to prevent surface potential from decreasing with repetitions of use; and to prevent local fluctuations of surface potential which are causative of image defects. The undercoat layer is not essential for the impartation of photoconductive properties.

The undercoat layer to be used in the electrophotographic photoreceptor of the invention may be, for example, one made of a resin or one constituted of a resin and particles of, e.g., a metal oxide dispersed therein. Examples of the metal oxide particles for use in the undercoat layer include particles of a metal oxide containing one metallic element, such as titanium oxide, aluminum oxide, silicon oxide, zirconium oxide, zinc oxide, or iron oxide, and particles of a metal oxide containing two or more metallic elements, such as calcium titanate, strontium titanate, or barium titanate. Particles of one kind may be used alone, or a mixture of two or more kinds of particles may be used. Preferred of those particulate metal oxides are titanium oxide and aluminum oxide. Titanium oxide is especially preferred. The titanium oxide particles may be ones whose surface has undergone a treatment with an inorganic substance such as tin oxide, aluminum oxide, antimony oxide, zirconium oxide, or silicon oxide or with an organic substance such as stearic acid, a polyol, or a silicone. With respect to the crystal form of the titanium oxide particles, any of the rutile, anatase, brookite, and amorphous forms is usable. The titanium oxide particles may be ones including particles having two or more crystal states.

Metal oxide particles having various particle diameters can be utilized. However, from the standpoints of properties and fluid stability, the particle diameter of the metal oxide particles in terms of average primary-particle diameter is preferably from 10 nm to 100 nm, especially preferably from 10 nm to 50 nm.

It is desirable that an undercoat layer be formed so as to be constituted of a binder resin and metal oxide particles dispersed therein. Examples of the binder resin for use in the undercoat layer include phenoxies, epoxies, polyvinylpyrrolidone, poly(vinyl alcohol), casein, poly(acrylic acid), cellulose derivatives, gelatin, starch, polyurethanes, polyimides, and polyamides. These materials may be used alone or in a cured form obtained by using a curing agent therewith. Of those materials, alcohol-soluble copolyamides, modified polyamides, and the like are preferred because such polymers have satisfactory dispersing properties and satisfactory coating property.

The proportion of the inorganic particles to the binder resin can be selected at will. However, it is preferred to use the inorganic particles in an amount in the range of from 10 wt % to 500 wt % from the standpoint of the stability and coating property of the dispersion.

The thickness of the undercoat layer can be selected at will. However, from the standpoint of photoreceptor characteristics and coating property, the thickness thereof is preferably from 0.1 μm to 25 μm. A known antioxidant and other additives may be added to the undercoat layer.

<Charge-Generating Layer>

In the case where the electrophotographic photoreceptor of the invention is a multilayer type photoreceptor, various photoconductive materials can be used as a charge-generating material in the charge-generating layer of the photoreceptor. Examples of the photoconductive materials include inorganic photoconductive materials such as selenium, alloys thereof, and cadmium sulfide and organic pigments such as phthalocyanine pigments, azo pigments, quinacridone pigments, indigo pigments, perylene pigments, polycyclic quinone pigments, anthanthrone pigments, and benzimidazole pigments. Especially preferred are organic pigments. More preferred are phthalocyanine pigments and azo pigments. Such a charge-generating material is used in the form of fine particles fixed with any of various binders such as, e.g., polyester resins, poly(vinyl acetate), poly(acrylic ester)s, poly(methacrylic ester)s, polyesters, polycarbonates, poly(vinyl acetoacetal), poly(vinyl propional), poly(vinyl butyral), phenoxy resins, epoxy resins, urethane resins, cellulose esters, and cellulose ethers. In this case, the proportion of the charge-generating material to be used may be in the range of from 30 to 500 parts by weight per 100 parts by weight of the binder resin. It is preferred that the thickness of the layer should be generally from 0.1 μm to 1 μm, preferably from 0.15 μm to 0.6 μm.

When a phthalocyanine compound is employed as a charge-generating substance, examples of usable phthalocyanine compounds include metal-free phthalocyanines and phthalocyanines to which a metal, e.g., copper, indium, gallium, tin, titanium, zinc, vanadium, silicon, or germanium, or an oxide, halide, or another form of the metal has coordinated. Examples of ligands coordinating to metal atoms having a valence of 3 or higher include a hydroxy group and alkoxy groups besides the oxygen atom and chlorine atom shown above. Especially preferred are X-form and τ-form metal-free phthalocyanines, which have high sensitivity, and A-form, B-form, D-form and other titanyl phthalocyanine, vanadyl phthalocyanine, chloroindium phthalocyanine, chlorogallium phthalocyanine, and hydroxygallium phthalocyanine. Incidentally, of the crystal forms of titanyl phthalocyanine mentioned above, A-form and B-form were respectively referred to as I-phase and II-phase by W. Heller et al. (Zeit. Kristallogr., 159 (1982) 173), A-form being known as a stable form. D-form is a crystal form characterized by showing a distinct peak at a diffraction angle 2θ±0.2° of 27.3° in X-ray powder diffractometry using a CuK_{α}, line. A single phthalocyanine compound may be used alone, or some phthalocyanine compounds in a mixture state may be used. The mixture state of phthalocyanine compounds or of crystal states may be one obtained by mixing the constituent elements later or may be one formed in phthalocyanine compound production/treatment steps including synthesis, pigment preparation, and crystallization. Known treatments for forming the mixture state include an acid paste treatment, grinding treatment, and solvent treatment.

<Charge-Transporting Layer>

In the case of a multilayer type photoreceptor as an embodiment of the invention, the charge-transporting layer contains a charge-transporting substance and optional ingredients besides the binder resin according to the invention. Such a charge-transporting layer can be obtained, for example, in the following manner. A charge-transporting substance and other ingredients are dissolved or dispersed in a solvent together with the binder resin to produce a coating fluid. In the case of a normal multilayer type photosensitive layer, the coating fluid is applied on a charge-generating layer. In the case of a reverse multilayer type photosensitive layer, the coating fluid is applied on a conductive base (or on an undercoat layer when the base has the undercoat layer). The coating fluid applied is dried to obtain the charge-transporting layer.

It is essential that the binder resin to be used for the charge-transporting layer should include the resin according to the invention. However, this resin may be used in combination with other resins. Examples of the other resins include butadiene resins, styrene resins, vinyl acetate resins, vinyl chloride resins, acrylic ester resins, methacrylic ester resins, vinyl alcohol resins, polymers and copolymers of vinyl compounds such as ethyl vinyl ether, poly(vinyl butyral) resins, poly(vinyl formal) resins, partly modified poly(vinyl acetal), polycarbonate resins, polyester resins, polyarylate resins, polyamide resins, polyurethane resins, cellulose ester resins, phenoxy resins, silicone resins, silicone-alkyd resins, and poly-N-vinylcarbazole resins. Preferred of these are polycarbonate resins and polyarylate resins. Those binder resins may be used together with an appropriate hardener and crosslinked with heat, light, etc. However, the proportion by weight of the binder resin according to the invention in all binder resins is preferably 50% or higher, more preferably 70% or higher, most preferably 100%.

The charge-transporting substance is not particularly limited, and any desired charge-transporting substance can be used. Examples of known charge-transporting substances include: electron-attracting compounds such as aromatic nitro compounds, e.g., 2,4,7-trinitrofluorenone, cyano compounds, e.g., tetracyanoquinodimethane, and quinone compounds, e.g., diphenoquinone; and electron-donating substances such as heterocyclic compounds, e.g., carbazole derivatives, indole derivatives, imidazole derivatives, oxazole derivatives, pyrazole derivatives, thiadiazole derivatives, and benzofuran derivatives, aniline derivatives, hydrazone derivatives, aromatic amine derivatives, stilbene derivatives, butadiene derivatives, enamine derivatives, compounds each constituted of two or more of these compounds bonded to each other, and polymers having a group derived from any of those compounds in the main chain or a side chain thereof. Preferred of these are carbazole derivatives, hydrazone derivatives, aromatic amine derivatives, stilbene derivatives, butadiene derivatives, enamine derivatives, and compounds each constituted of two or more of these compounds bonded to each other. Any one of these charge-transporting substances may be used alone, or any desired two or more thereof may be used in combination.

A charge-transporting layer is constituted of such a charge-transporting substance and the binder resin according to the invention with which the charge-transporting substance is fixed. The charge-transporting layer may be constituted of a single layer or may be composed of superposed layers differing in component or composition.

With respect to the proportion of the binder resin to the charge-transporting substance, the charge-transporting substance may be used in an amount of 20 parts by weight or larger per 100 parts by weight of the binder resin. In particular, the amount thereof is preferably 30 parts by weight or larger from the standpoint of reducing residual potential, and is more preferably 40 parts by weight or larger from the standpoints of stability in repetitions of use and charge mobility. On the other hand, from the standpoint of the thermal stability of the photosensitive layer, the charge-transporting substance is used generally in an amount of 150 parts by weight or smaller. In particular, the amount thereof is preferably 110 parts by weight or smaller from the standpoint of compatibility between the charge-transporting material and the binder resin, is more preferably 80 parts by weight or smaller from the standpoint of printing durability, and is most preferably 70 parts by weight or smaller from the standpoint of marring resistance.

The thickness of the charge-transporting layer is not particularly limited. However, from the standpoints of long life and image stability and from the standpoint of high resolution, the thickness of the charge-transporting layer is in the range of from generally 5 μm, preferably 10 μm, to generally 50 μm, preferably 45 μm, more preferably 30 μm.

Known additives such as a plasticizer, antioxidant, ultraviolet absorber, electron-attracting compound, dye, pigment, and leveling agent may be incorporated in the charge-transporting layer in order to improve film-forming properties, flexibility, coating property, nonfouling properties, gas resistance, light resistance, etc. Examples of the antioxidant include hindered phenol compounds and hindered amine compounds. Examples of the dye and pigment include various colorant compounds and azo compounds.

<Dispersion Type (Single-Layer Type) Photosensitive Layer>

In the case of a dispersion type photosensitive layer, the charge-generating substance is dispersed in a charge-transporting medium having the composition described above.

In this case, the particle diameter of the charge-generating substance to be used must be sufficiently small, and is preferably 1 μm or smaller, more preferably 0.5 μm or smaller. In case where the amount of the charge-generating substance dispersed in the photosensitive layer is too small, sufficient sensitivity is not obtained. In case where the amount thereof is too large, this exerts adverse influences and results in a decrease in electrification characteristics, decrease in sensitivity, etc. The charge-generating substance is used, for example, in an amount preferably in the range of 0.5-50% by weight, more preferably in the range of 1-20% by weight.

The thickness of the photosensitive layer is generally 5-50 μm, more preferably 10-45 μm. In this case also, the photosensitive layer may contain a known plasticizer for improving film-forming properties, flexibility, mechanical strength, etc., an additive for diminishing residual potential, a dispersing aid for improving dispersion stability, a leveling agent or surfactant for improving coating property, such as, e.g., a silicone oil or a fluorochemical oil, and other additives.

A protective layer may be formed on the photosensitive layer for the purposes of preventing the photosensitive layer from wearing and of preventing or diminishing the photosensitive-layer deterioration caused by, e.g., discharge products generating from a charging device, etc.

A surface layer may contain a fluororesin, silicone resin, or the like for the purpose of reducing the frictional resistance or wear of the photoreceptor surface. Furthermore, the surface layer may contain particles containing any of these resins or particles of an inorganic compound.

<Process for Producing Electrophotographic Photoreceptor>

Processes for producing electrophotographic photoreceptors to which this embodiment is applied are not particularly limited. In general, however, each of the layers for constituting such an electrophotographic photoreceptor is formed by applying a coating fluid to a base by a known technique for forming the photosensitive layers of electrophotographic photoreceptors, such as dip coating, spray coating, nozzle coating, bar coating, roll coating, or blade coating. Of these, dip coating is preferred from the standpoint of high productivity.

For forming the layers, a known method can be used. For example, coating fluids each obtained by dissolving or dispersing substances to be incorporated into the layer in a solvent are successively applied to form the layers.

It is preferred that the photosensitive layer possessed by the electrophotographic photoreceptor of the invention should contain an aromatic hydrocarbon as a residual solvent. The term “residual solvent” as used in the invention generally means one derived from a solvent used in the coating fluid. The residual amount thereof can be determined by analysis by gas chromatography. In the invention, a solvent which is present in an amount of 0.01 mg/cm³ or larger is regarded as a residual solvent. In the case where an aromatic hydrocarbon is used as a solvent in a coating fluid as in the invention, a residual solvent usually remains in the photoreceptor.

<Image-Forming Apparatus>

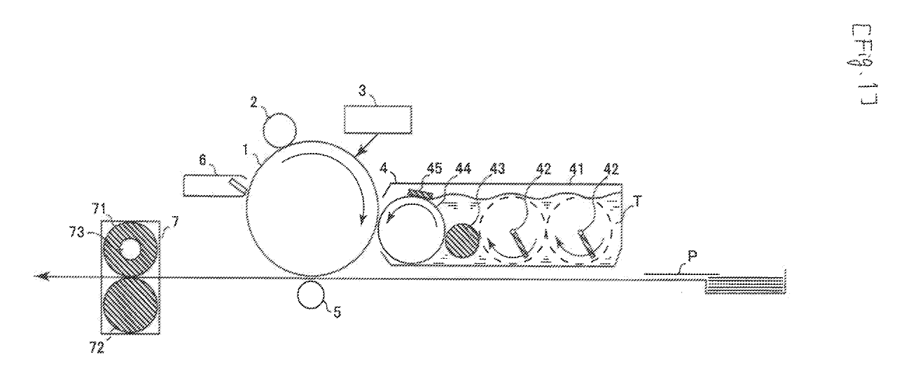

Embodiments of the image-forming apparatus employing the electrophotographic photoreceptor of the invention are explained next by reference to FIG. 1, which illustrates the constitution of important parts of the apparatus. However, embodiments thereof should not be construed as being limited to the following explanations, and any desired modifications can be made unless they depart from the spirit of the invention.

As shown in FIG. 1, this image-forming apparatus includes an electrophotographic photoreceptor 1, a charging device 2, an exposure device 3, and a development device 4. A transfer device 5, a cleaning device 6, and a fixing device 7 are further disposed according to need.

The electrophotographic photoreceptor 1 is not particularly limited so long as it is the electrophotographic photoreceptor of the invention described above. FIG. 1 shows one example thereof, which is a drum-form photoreceptor obtained by forming the photosensitive layer described above on the surface of a cylindrical conductive baset. The charging device 2, exposure device 3, development device 4, transfer device 5, and cleaning device 6 have been disposed along the peripheral surface of the electrophotographic photoreceptor 1.

The charging device 2 charges the electrophotographic photoreceptor 1. It evenly charges the surface of the electrophotographic photoreceptor 1 to a given potential. FIG. 1 shows a roller type charging device (charging roller) as an example of the charging device 2. Other charging devices in frequent use include corona-charging devices such as corotrons and scorotrons and contact type charging devices such as charging brushes.

In many cases, the electrophotographic photoreceptor 1 and the charging device 2 are designed as a cartridge including both (hereinafter referred to as photoreceptor cartridge) so that the cartridge can be demounted from the image-forming apparatus main body. When, for example, the electrophotographic photoreceptor 1 or the charging device 2 has deteriorated, this photoreceptor cartridge can be demounted from the image-forming apparatus main body and a fresh photoreceptor cartridge can be mounted in the image-forming apparatus main body. With respect to a toner also, which will be described later, it in many cases is designed to be stored in a toner cartridge and be capable of being demounted from the image-forming apparatus main body. When the toner cartridge which is being used has run out of the toner, this toner cartridge can be demounted from the image-forming apparatus main body and a fresh toner cartridge can be mounted. There also are cases where a cartridge including all of the electrophotographic photoreceptor 1, charging device 2, and toner is used.

The kind of the exposure device 3 is not particularly limited so long as it can illuminate the electrophotographic photoreceptor 1 to form an electrostatic latent image on the photosensitive surface of the electrophotographic photoreceptor 1. Examples thereof include halogen lamps, fluorescent lamps, lasers such as semiconductor lasers and He—Ne lasers, and LEDs. The technique of internal photoreceptor exposure may be used to conduct exposure. Any desired light may be used for exposure. It is however preferred that the photoreceptor 1 should be exposed to a monochromatic light especially having a short wavelength of, e.g., 380 nm to 500 nm. More preferred is to expose the photoreceptor 1 to a monochromatic light having a wavelength of 380 nm to 430 nm.

The kind of the development device 4 is not particularly limited, and any desired device can be used, such as, e.g., one of the dry development type employing cascade development, development with a one-component conductive toner, or magnetic-brush development with two components or one of the wet development type. The development device 4 in FIG. 1 includes a developing vessel 41, agitators 42, a feed roller 43, a developing roller 44, and a control member 45. It has a constitution in which a toner T is stored in the developing vessel 41. According to need, a replenisher (not shown) for replenishing the toner T may be attached to the development device 4. This replenisher is constituted so that the toner T can be replenished from a container such as a bottle or cartridge.

The feed roller 43 is constituted, for example, of a conductive sponge. The developing roller 44 includes, for example, a metallic roll made of iron, stainless steel, aluminum, or nickel or a resin roll obtained by coating such a metallic roll with a silicone resin, urethane resin, fluororesin, or the like. The surface of this developing roller 44 may be subjected to smoothing processing or roughening processing according to need.

The developing roller 44 has been disposed between the electrophotographic photoreceptor 1 and the feed roller 43 and is in contact with each of the electrophotographic photoreceptor 1 and the feed roller 43. The feed roller 43 and the developing roller 44 are rotated by a rotating/driving mechanism (not shown). The feed roller 43 holds the toner T stored and feeds it to the developing roller 44. The developing roller 44 holds the toner T fed by the feed roller 43 and brings it into contact with the surface of the electrophotographic photoreceptor 1.

The control member 45 is constituted, for example, of a resin blade made of a silicone resin, urethane resin, or the like, a metallic blade made of stainless steel, aluminum, copper, brass, phosphor bronze, or the like, or a blade obtained by coating such as a metallic blade with a resin. This control member 45 is in contact with the developing roller 44 and is being pressed against the developing roller 44 at a given force (linear blade pressure is generally 5-500 g-weight/cm) with a spring or the like. According to need, the function of charging the toner T based on friction with the toner T may be imparted to the control member 45.

The agitators 42 are rotated by the rotating/driving mechanism. They agitate the toner T and send the toner T to the feed roller 43 side. The agitators 42 may be ones differing in blade shape, size, etc.

The kind of the toner T is not limited. Besides a powdery toner, usable toners include a polymerization toner produced by the suspension polymerization method, emulsion polymerization method, etc. Especially when a polymerization toner is to be employed, one having a small particle diameter of about 4-8 μm is preferred, and ones having various toner particle shapes ranging from a nearly spherical shape to a non-spherical potato shape can be used. Polymerization toners are excellent in electrification evenness and transferability and are suitable for use in attaining high image quality.

The kind of the transfer device 5 is not particularly limited, and use can be made of a device of any desired type working by the electrostatic transfer method, pressure transfer method, adhesion transfer method, or the like, such as corona transfer, roller transfer, or belt transfer. In this embodiment, the transfer device 5 is constituted of a transfer charger, transfer roller, transfer belt, or the like disposed so as to face the electrophotographic photoreceptor 1. A given voltage (transfer voltage) which has the polarity opposite to that of the charge potential of the toner T is applied to the transfer device 5, and this transfer device 5 thus transfers a toner image formed on the electrophotographic photoreceptor 1 to a recording paper (paper or medium) P.

The cleaning device 6 is not particularly limited, and any desired cleaning device can be employed, such as, e.g., a brush cleaner, magnetic brush cleaner, electrostatic brush cleaner, magnetic roller cleaner, or blade cleaner. The cleaning device 6 serves to scrape off the residual toner adherent to the photoreceptor 1 with a cleaning member and recover the residual toner. However, in the case where the amount of the toner remaining on the photoreceptor surface is small or almost nil, the cleaning device 6 may be omitted.

The fixing device 7 is constituted of an upper fixing member (pressure roller) 71 and a lower fixing member (fixing roller) 72. The fixing member 71 or 72 is equipped with a heater 73 inside. In the example shown in FIG. 1, the upper fixing member 71 is equipped with a heater 73 inside. The upper and lower fixing members 71 and 72 each can be a known heat-fixing member such as, e.g., a fixing roll obtained by coating a metallic pipe made of, e.g., stainless steel or aluminum with a silicone rubber, a fixing roll obtained by further coating the rubber-coated pipe with Teflon (registered trademark), or a fixing sheet. The fixing members 71 and 72 may have a constitution in which a release agent, e.g., a silicone oil, is supplied thereto in order to improve release properties, or may have a constitution in which the two members are forcedly pressed against each other with a spring or the like.

The toner transferred to the recording paper P passes through the nip between the upper fixing member 71 heated at a given temperature and the lower fixing member 72, during which the toner is heated to a molten state. After the passing, the toner is cooled and fixed to the recording paper P.

The kind of the fixing device also is not particularly limited. Besides the fixing device used here, a fixing device of any desired type can be employed, such as one for hot-roller fixing, flash fixing, oven fixing, or pressure fixing.

In the electrophotographic apparatus having the constitution described above, an image is recorded in the following manner. First, the surface (photosensitive surface) of the photoreceptor 1 is charged to a given potential (e.g., −600 V) by the charging device 2. This charging may be accomplished with a direct-current voltage or with a direct-current voltage on which an alternating-current voltage has been superimposed.

Subsequently, the charged photosensitive surface of the photoreceptor 1 is exposed by the exposure device 3 according to the image to be recorded. Thus, an electrostatic latent image is formed on the photosensitive surface. This electrostatic latent image formed on the photosensitive surface of the photoreceptor 1 is developed by the developing device 4.

In the developing device 4, a toner T fed by the feed roller 43 is formed into a thin layer with the control member (developing blade) 45 and, simultaneously therewith, frictionally charged so as to have a given polarity (here, the toner is charged so as to have negative polarity, which is the same as the polarity of the charge potential of the photoreceptor 1). This toner T is conveyed while being held by the developing roller 44 and is brought into contact with the surface of the photoreceptor 1.

When the charged toner T held on the developing roller 44 comes into contact with the surface of the photoreceptor 1, a toner image corresponding to the electrostatic latent image is formed on the photosensitive surface of the photoreceptor 1. This tone image is transferred to a recording paper P by the transfer device 5. Thereafter, the toner which has not been transferred and remains on the photosensitive surface of the photoreceptor 1 is removed by the cleaning device 6.

After the transfer of the toner image to the recording paper P, this recording paper P is passed through the fixing device 7 to thermally fix the toner image to the recording paper P. Thus, a finished image is obtained.

Incidentally, the image-forming apparatus may have a constitution in which an erase step, for example, can be conducted, in addition to the constitution described above. The erase step is a step in which the electrophotographic photoreceptor is exposed to a light to thereby erase the residual charges from the electrophotographic photoreceptor. As an eraser may be used a fluorescent lamp, LED, or the like. The light to be used in the erase step, in many cases, is a light having such an intensity that the exposure energy thereof is at least 3 times the energy of the exposure light.

The constitution of the image-forming apparatus may be further modified. For example, the apparatus may have a constitution in which steps such as a pre-exposure step and an auxiliary charging step can be conducted, or have a constitution in which offset printing is conducted. Furthermore, the apparatus may have a full-color tandem constitution employing two or more toners.

### EXAMPLES

This embodiment will be explained below in more detail by reference to Examples. The following Examples are intended to illustrate the invention in detail, and the invention should not be construed as being limited to the following Examples unless it departs from the spirit thereof. Each “parts” used in the following Examples, Comparative Examples, and Reference Examples is “parts by weight” unless otherwise indicated.

<Production of Resins>

First, the determination of viscosity-average molecular weight is explained.

A polycarbonate resin is dissolved in dichloromethane to prepare a solution having a concentration C of 6.00 g/L. An Ubbelohde capillary viscometer having an efflux time for the solvent (dichloromethane) t₀ of 136.16 seconds is used to measure the efflux time of the sample solution t in a thermostatic water tank set at 20.0° C. The viscosity-average molecular weight Mv is calculated according to the following equations.

a=0.438×ηₛₚ+1 ηₛₚ=t/t₀−1

b=100×ηₛₚ/C C=6.00 (g/L)

η=b/a

Mv=3207×η^{1.205}

Processes for producing polycarbonate resins are explained below.

### Oligomer A Production Example

A mixture of 100 parts (0.438 mol) of 2,2-bis(4-hydroxyphenyl)propane (referred to as bisphenol A), 45.6 parts (1.14 mol) of sodium hydroxide, 848 parts of water, 0.336 parts of sodium hydrosulfite, and 432 parts (325 mL) of methylene chloride was introduced into a reaction vessel equipped with a stirrer. The contents were stirred. While the temperature in the reaction vessel was kept at 0-10° C., 110 parts (1.11 mol) of phosgene was bubbled into the mixture over above 6 hours and reacted. After completion of the reaction, a methylene chloride solution containing a polycarbonate oligomer was isolated. The resultant oligomer solution in methylene chloride was analyzed, and the results thereof were as follows.

Oligomer concentration (note 1): 21.9% by weight

Concentration of terminal chloroformate group (note 2): 0.420 N

Concentration of terminal phenolic hydroxyl group (note 3): 0.026 N

(Note 1): Determined by evaporating the solution to dryness.

(Note 2): The oligomer was reacted with aniline, and the resultant aniline hydrochloride was subjected to neutralization titration with 0.2 N aqueous sodium hydroxide solution.

(Note 3): The oligomer was dissolved in methylene chloride, titanium tetrachloride, and an acetic acid solution, and the resultant solutions were examined for coloration by colorimetric analysis at 546 nm.

### Oligomer C Production Example

The same procedure as in Oligomer A Production Example was conducted, except that 100 parts (0.391 mol) of 2,2-bis(4-hydroxy-3-methylphenyl)propane (referred to as bisphenol C) was used. The resultant oligomer C solution in methylene chloride was analyzed, and the results thereof were as follows.

Oligomer concentration (note 1): 25.2% by weight

Concentration of terminal chloroformate group (note 2): 0.560 N

Concentration of terminal phenolic hydroxyl group (note 3): 0.326 N

### Oligomer X Production Example

The same procedure as in Oligomer A Production Example was conducted, except that 100 parts (0.345 mol) of 4,4′-(1-phenylethylidene)bisphenol (referred to as bisphenol X) was used. The resultant oligomer X solution in methylene chloride was analyzed, and the results thereof were as follows.

Oligomer concentration (note 1): 22.6% by weight

Concentration of terminal chloroformate group (note 2): 0.322 N

Concentration of terminal phenolic hydroxyl group (note 3): 0.016 N

### Oligomer AC Production Example

The same procedure as in Oligomer A Production Example was conducted, except that 70 parts (0.307 mol) of 2,2-bis(4-hydroxyphenyl)propane and 33.7 parts (0.132 mol) of 2,2-bis(4-hydroxy-3-methylphenyl)propane were used. The resultant oligomer AC solution in methylene chloride was analyzed, and the results thereof were as follows.

Oligomer concentration (note 1): 22.9% by weight

Concentration of terminal chloroformate group (note 2): 0.462 N

Concentration of terminal phenolic hydroxyl group (note 3): 0.116 N

### Oligomer CX Production Example

The same procedure as in Oligomer A Production Example was conducted, except that 56 parts (0.219 mol) of 2,2-bis(4-hydroxy-3-methylphenyl)propane and 63.5 parts (0.219 mol) of 4,4′-(1-phenylethylidene)bisphenol were used. The resultant oligomer CX solution in methylene chloride was analyzed, and the results thereof were as follows.

Oligomer concentration (note 1): 23.9% by weight

Concentration of terminal chloroformate group (note 2): 0.441 N

Concentration of terminal phenolic hydroxyl group (note 3): 0.171 N

### Production Example 1

Sodium hydroxide (12.57 g) and H₂O (171.30 mL) were weighed out and placed in a 100-mL beaker. The sodium hydroxide was dissolved in the water with stirring. Thereto were added p-tert-butylphenol (0.750 g) and 2% aqueous triethylamine solution (5.407 mL). The resultant mixture was stirred to dissolve the ingredients added. Thus, an aqueous alkali solution was prepared.

Subsequently, the oligomer AC (465.27 g) produced above and dichloromethane (158.73 mL) were introduced into a 2-L reaction vessel equipped with a stirrer. While the external temperature of the polymerization vessel was kept at 20° C. with stirring, the aqueous alkali solution prepared above was introduced into the 2-L reaction vessel and the resultant mixture was stirred for 4 hours.

After completion of the reaction, a methylene chloride solution containing a polycarbonate was isolated. This solution was subjected to acid washing, alkali washing, and water washing. Thereafter, the solvent was removed to obtain a target polycarbonate resin.

### Production Example 2

The same procedure as in Production Example 1 was conducted, except that p-tert-butylphenol (1.000 g) was used. Thus, a target polycarbonate resin was obtained.

### Production Example 3

The same procedure as in Production Example 1 was conducted, except that p-tert-butylphenol (1.200 g) was used. Thus, a target polycarbonate resin was obtained.

### Production Example 4

Sodium hydroxide (12.59 g) and H₂O (171.30 mL) were weighed out and placed in a beaker. The sodium hydroxide was dissolved in the water with stirring. Thereto were added p-tert-butylphenol (0.750 g) and 2% aqueous triethylamine solution (5.407 mL). The resultant mixture was stirred to dissolve the ingredients added. Thus, an aqueous alkali solution was prepared.

Subsequently, the oligomer A (329.69 g) and oligomer C (136.31 g) produced above and dichloromethane (158.19 mL) were introduced into a 2-L reaction vessel equipped with a stirrer. While the external temperature of the polymerization vessel was kept at 20° C. with stirring, the aqueous alkali solution prepared above was introduced into the 2-L reaction vessel and the resultant mixture was stirred for 4 hours.

After completion of the reaction, a methylene chloride solution containing a polycarbonate was isolated. This solution was subjected to acid washing, alkali washing, and water washing. Thereafter, the solvent was removed to obtain a target polycarbonate resin.

### Production Example 5

The same procedure as in Production Example 4 was conducted, except that p-tert-butylphenol (1.000 g) was used. Thus, a target polycarbonate resin was obtained.

### Production Example 6

The same procedure as in Production Example 4 was conducted, except that p-tert-butylphenol (1.200 g) was used. Thus, a target polycarbonate resin was obtained.

### Production Example 7

Sodium hydroxide (10.67 g) and H₂O (171.04 mL) were weighed out and placed in a beaker. The sodium hydroxide was dissolved in the water with stirring. Thereto were added p-tert-butylphenol (1.000 g) and 2% aqueous triethylamine solution (5.407 mL). The resultant mixture was stirred to dissolve the ingredients added. Thus, an aqueous alkali solution was prepared.

Subsequently, the oligomer CX (441.57 g) produced above and dichloromethane (176.05 mL) were introduced into a 2-L reaction vessel equipped with a stirrer. While the external temperature of the polymerization vessel was kept at 20° C. with stirring, the aqueous alkali solution prepared above was introduced into the 2-L reaction vessel and the resultant mixture was stirred for 4 hours.

After completion of the reaction, a methylene chloride solution containing a polycarbonate was isolated. This solution was subjected to acid washing, alkali washing, and water washing. Thereafter, the solvent was removed to obtain a target polycarbonate resin (viscosity-average molecular weight, 30,300).

### Production Example 8

Sodium hydroxide (10.99 g) and H₂O (171.31 mL) were weighed out and placed in a beaker. The sodium hydroxide was dissolved in the water with stirring. Thereto were added p-tert-butylphenol (1.000 g) and 2% aqueous triethylamine solution (5.407 mL). The resultant mixture was stirred to dissolve the ingredients added. Thus, an aqueous alkali solution was prepared.

Subsequently, the oligomer C (201.46 g) and oligomer X (246.94 g) produced above and dichloromethane (171.64 mL) were introduced into a 2-L reaction vessel equipped with a stirrer. While the external temperature of the polymerization vessel was kept at 20° C. with stirring, the aqueous alkali solution prepared above was introduced into the 2-L reaction vessel and the resultant mixture was stirred for 4 hours.

After completion of the reaction, a methylene chloride solution containing a polycarbonate was isolated. This solution was subjected to acid washing, alkali washing, and water washing. Thereafter, the solvent was removed to obtain a target polycarbonate resin (viscosity-average molecular weight, 31,000).

In the following Table 1 are shown the viscosity-average molecular weight of each of the resins produced in Production Examples 1 to 6, the proportions of the repeating unit structure derived from oligomer A and repeating unit structure derived from oligomer C which were determined through ¹H-NMR spectroscopy by the method described above, and the average numbers of repetitions of these structures.

TABLE 1

| | viscosity- | Proportion of unit | | Average number of | |
|---|---|---|---|---|---|
| | average | (by mole) | | repetitions | |
| | molecular | Oligomer | Oligomer | Oligomer | |
| | weight | A | C | A | Oligomer C |
| Production | 40,200 | 0.72 | 0.28 | 3.3 | 1.3 |
| Example 1 | | | | | |
| Production | 30,100 | 0.75 | 0.25 | 3.0 | 1.0 |
| Example 2 | | | | | |
| Production | 25,400 | 0.73 | 0.27 | 3.1 | 1.1 |
| Example 3 | | | | | |
| Production | 40,300 | 0.75 | 0.25 | 12.2 | 4.2 |
| Example 4 | | | | | |
| Production | 30,300 | 0.75 | 0.25 | 13.0 | 4.3 |
| Example 5 | | | | | |
| Production | 25,000 | 0.73 | 0.27 | 11.0 | 4.1 |
| Example 6 | | | | | |

### Example 1

In 596 parts by weight of a tetrahydrofuran/toluene (weight ratio, 8/2) mixed solvent were dissolved 100 parts by weight of the resin produced in Production Example 1, 60 parts by weight of a charge-transporting substance constituted of a composition of geometrical isomers having the structure represented by the following formula (3), 8 parts by weight of 3,5-di-t-butyl-4-hydroxytoluene (BHT), and 0.03 parts by weight of a silicone oil as a leveling agent. Thus, a coating fluid for charge-transporting-layer formation was prepared. This coating fluid was stored in an environment of 25° C.±5° C. and examined for viscosity during this storage with a rotational viscometer (Type EMD, manufactured by Tokyo Keiki Inc.). The results concerning viscosity change with time are shown in Table 2. Incidentally, tetrahydrofuran has a boiling point of 66° C. and toluene has a boiling point of 111° C.

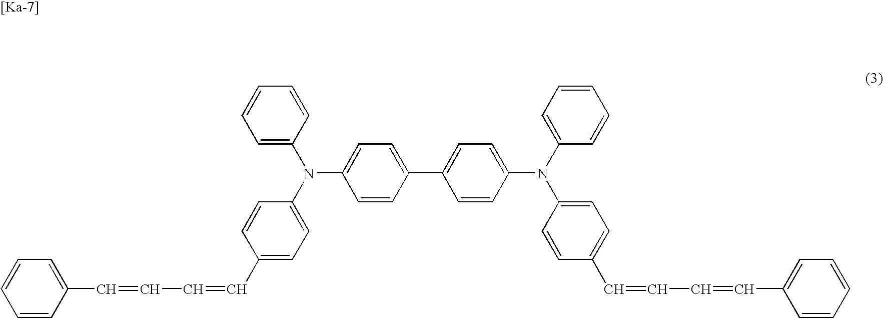

Rutile-form white titanium oxide having an average primary-particle diameter of 40 nm (product name, TTO55N; manufactured by Ishihara Sangyo Kasha, Ltd.) was introduced into a high-speed flow type mixing kneader (product name, SMG300; manufactured by Kawata MFG Co., Ltd.) together with 3% by weight methyldimethoxysilane (product name, TSL8117; manufactured by Toshiba Silicone Co., Ltd.) based on the titanium oxide. The ingredients were subjected to high-speed mixing (peripheral speed, 34.5 m/sec) to obtain a surface-treated titanium oxide. This hydrophobized titanium oxide was dispersed in a methanol/1-propanol mixed solvent with a ball mill to thereby obtain a dispersion slurry of the hydrophobized titanium oxide. This dispersion slurry was mixed with a methanol/1-propanol/toluene (weight ratio, 7/1/2) mixed solvent and pellets of a copolyamide constituted of ε-caprolactam/bis(4-amino-3-methylphenyl)methane/hexamethyl enediamine/decamethylenedicarboxylic acid/octadecamethylenedicarboxylic acid (proportion in terms of mol %, 60/15/5/15/5) with heating to dissolve the polyamide pellets. The resultant mixture was subjected to an ultrasonic dispersing treatment to thereby obtain a dispersion which contained the hydrophobized titanium oxide and the copolyamide in a former/latter weight ratio of 3/1 and had a solid concentration of 18.0%. A cylinder made of aluminum having a mirror-finished surface and having an outer diameter of 30 mm, length of 285 mm, and wall thickness of 1.0 mm was dip-coated with the dispersion to form an undercoat layer having a thickness of 2 μm on a dry basis.

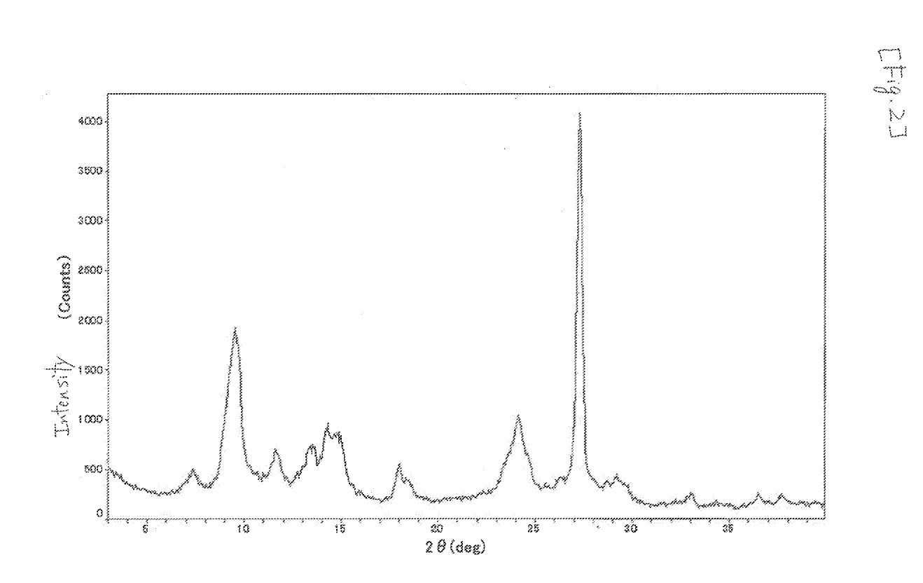

Separately from the operation described above, 20 parts by weight of an oxytitanium phthalocyanine having the X-ray powder diffraction spectrum shown in FIG. 2 in an examination with a CuKα line, as a charge-generating substance, was mixed with 280 parts by weight of 1,2-dimethoxyethane. This mixture was treated with a sand grinding mill for 2 hours to conduct a pulverization/dispersing treatment. Subsequently, this liquid which had undergone the pulverization treatment was mixed with a binder solution obtained by dissolving poly(vinyl butyral) (#6000C) in a liquid mixture of 490 parts by weight of 1,2-dimethoxyethane and 85 parts by weight of 4-methoxy-4-methyl-2-pentanone. Thus, a coating fluid for charge-generating-layer formation was prepared. This coating fluid was applied by dip coating to the aluminum cylinder on which the undercoat layer had been formed. Thus, a charge-generating layer having a thickness of 0.4 μm on a dry basis was formed.

Subsequently, the coating fluid for charge-transporting-layer formation produced above which had been stored for 30 days was applied to the charge-generating layer by dip coating. The coating fluid applied was dried at 125° C. for 24 minutes to form a charge-transporting layer having a thickness of 25 μm. Thus, an electrophotographic photoreceptor having a multilayer type photosensitive layer was produced.

The electrophotographic photoreceptor thus produced was evaluated for electrical properties. The photoreceptor was mounted in a photoreceptor property evaluation apparatus installed in an environmental testing room having a temperature of 25° C.±5° C. and a relative humidity of 50%±10%. This electrophotographic photoreceptor was charged so as to result in a surface potential of −700 V. Thereafter, the photoreceptor was irradiated with 780 nm light at various irradiation intensities and examined for surface potential at 200 msec after the irradiation. The surface potential resulting from irradiation with the light at an intensity of 1.0 μJ/cm² (hereinafter sometimes referred to as VLmax) was measured. Furthermore, the exposure intensity which caused the surface potential of the photoreceptor to become −350 V at 200 msec after the irradiation with 780 nm light was measured as half-decay exposure (hereinafter sometimes referred to as E1/2). The values thereof are shown in Table 3.

### Example 2

A coating fluid for charge-transporting-layer formation was prepared in the same manner as in Example 1, except that the resin produced in Production Example 2 was used in place of the resin of Production Example 1 used for the charge-transporting layer, and that the amount of the tetrahydrofuran/toluene (8/2 by weight) mixed solvent was changed from 596 parts by weight to 454 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Example 3

A coating fluid for charge-transporting-layer formation was prepared in the same manner as in Example 1, except that the resin produced in Production Example 3 was used in place of the resin of Production Example 1 used for the charge-transporting layer, and that the amount of the tetrahydrofuran/toluene (8/2 by weight) mixed solvent was changed from 596 parts by weight to 432 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Example 4

In 792 parts by weight of a tetrahydrofuran/toluene (weight ratio, 8/2) mixed solvent were dissolved 100 parts by weight of the resin produced in Production Example 1, 90 parts by weight of a charge-transporting substance having the structure represented by the following formula (4), 8 parts by weight of 3,5-di-t-butyl-4-hydroxytoluene (BHT), and 0.03 parts by weight of a silicone oil as a leveling agent. Thus, a coating fluid for charge-transporting-layer formation was prepared. This coating fluid was stored in an environment having a temperature of 15° C.±5° C. and examined for viscosity change with time during the storage in the same manner as in Example 1.

An electrophotographic photoreceptor was produced in the same manner as in Example 1, except that the coating fluid for charge-transporting-layer formation prepared in this Example was used and that the storage temperature was changed to 15° C.±5° C. The electrophotographic photoreceptor was evaluated in the same manner. The results obtained are shown in Table 2 and Table 3.

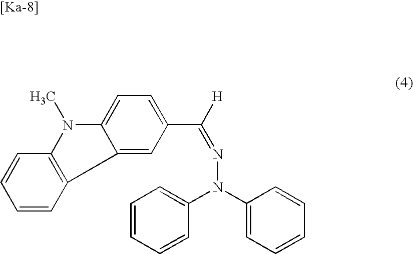

### Example 5

A coating fluid for charge-transporting-layer formation was prepared in the same manner as in Example 4, except that the resin produced in Production Example 2 was used in place of the resin of Production Example 1 used for the charge-transporting layer, and that the amount of the tetrahydrofuran/toluene (8/2 by weight) mixed solvent was changed from 792 parts by weight to 509 parts by weight. The viscosity of this coating fluid was measured in the same manner as in Example 4. An electrophotographic photoreceptor was produced using this coating fluid in the same manner as in Example 4 and examined for electrical properties. The results obtained are shown in Table 2 and Table 3.

### Example 6

A coating fluid for charge-transporting-layer formation was prepared in the same manner as in Example 4, except that the resin produced in Production Example 3 was used in place of the resin of Production Example 1 used for the charge-transporting layer, and that the amount of the tetrahydrofuran/toluene (8/2 by weight) mixed solvent was changed from 792 parts by weight to 485 parts by weight. The viscosity of this coating fluid was measured in the same manner as in Example 4. An electrophotographic photoreceptor was produced using this coating fluid in the same manner as in Example 4 and examined for electrical properties. The results obtained are shown in Table 2 and Table 3.

### Example 7

A coating fluid for charge-transporting-layer formation was prepared in the same manner as in Example 1, except that the resin produced in Production Example 4 was used in place of the resin of Production Example 1 used for the charge-transporting layer. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Example 8

A coating fluid for charge-transporting-layer formation was prepared in the same manner as in Example 1, except that the resin produced in Production Example 5 was used in place of the resin of Production Example 1 used for the charge-transporting layer, and that the amount of the tetrahydrofuran/toluene (8/2 by weight) mixed solvent was changed from 596 parts by weight to 454 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Example 9

A coating fluid for charge-transporting-layer formation was prepared in the same manner as in Example 1, except that the resin produced in Production Example 6 was used in place of the resin of Production Example 1 used for the charge-transporting layer, and that the amount of the tetrahydrofuran/toluene (8/2 by weight) mixed solvent was changed from 596 parts by weight to 432 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 1

A coating fluid for charge-transporting-layer formation was prepared in the same manner as in Example 1, except that the tetrahydrofuran/toluene (8/2 by weight) mixed solvent used in Example 1 as a solvent for the coating fluid for charge-transporting-layer formation was replaced by a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3. Incidentally, anisole has a boiling point of 154° C.

### Comparative Example 2

A coating fluid for charge-transporting-layer formation was prepared in the same manner as in Example 1, except that the resin produced in Production Example 2 was used in place of the resin of Production Example 1 used for the charge-transporting layer, and that the tetrahydrofuran/toluene (8/2 by weight) mixed solvent was replaced by 454 parts by weight of a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 3

A coating fluid for charge-transporting-layer formation was prepared in the same manner as in Example 1, except that the resin produced in Production Example 3 was used in place of the resin of Production Example 1 used for the charge-transporting layer, and that the tetrahydrofuran/toluene (8/2 by weight) mixed solvent was replaced by 432 parts by weight of a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 4

A coating fluid for charge-transporting-layer formation was prepared in the same manner as in Example 1, except that the resin produced in Production Example 4 was used in place of the resin of Production Example 1 used for the charge-transporting layer, and that the tetrahydrofuran/toluene (8/2 by weight) mixed solvent was replaced by a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 5

A coating fluid for charge-transporting-layer formation was prepared in the same manner as in Example 1, except that the resin produced in Production Example 5 was used in place of the resin of Production Example 1 used for the charge-transporting layer, and that the tetrahydrofuran/toluene (8/2 by weight) mixed solvent was replaced by 454 parts by weight of a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 6

A coating fluid for charge-transporting-layer formation was prepared in the same manner as in Example 1, except that the resin produced in Production Example 6 was used in place of the resin of Production Example 1 used for the charge-transporting layer, and that the tetrahydrofuran/toluene (8/2 by weight) mixed solvent was replaced by 432 parts by weight of a tetrahydrofuran/anisole (9/1 by weight) mixed solvent. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 7

A coating fluid for charge-transporting-layer formation was prepared in the same manner as in Example 1, except that the resin produced in Production Example 7 was used in place of the resin of Production Example 1 used for the charge-transporting layer, and that the amount of the tetrahydrofuran/toluene (8/2 by weight) mixed solvent was changed from 596 parts by weight to 454 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

### Comparative Example 8

A coating fluid for charge-transporting-layer formation was prepared in the same manner as in Example 1, except that the resin produced in Production Example 8 was used in place of the resin of Production Example 1 used for the charge-transporting layer, and that the amount of the tetrahydrofuran/toluene (8/2 by weight) mixed solvent was changed from 596 parts by weight to 454 parts by weight. The viscosity of this coating fluid was measured in the same manner as in Example 1. An electrophotographic photoreceptor was produced using this coating fluid in the same manner as in Example 1 and examined for electrical properties. The results obtained are shown in Table 2 and Table 3.

The photosensitive layer of each photoreceptor produced was peeled off and examined by gas chromatography for the amount of any aromatic hydrocarbon solvent present therein. As a result, toluene was detected in each of the photoreceptors of Examples 1 to 9 in an amount of 0.1 mg/cm³ or larger. In contrast, no aromatic hydrocarbon solvent was detected in the photoreceptors of Comparative Examples 1 to 6.

Furthermore, photoreceptors were obtained in the same manners as in Examples 1 to 3, except that the coating fluids were stored in an environment of 25° C.±5° C. for 100 days and then used to form a photosensitive layer. Each photoreceptor was mounted in a photoreceptor cartridge for color laser printer LP1500C, manufactured by Seiko Epson Corp. This photoreceptor cartridge was mounted in the color laser printer and images were formed. As a result, satisfactory images were obtained.

Moreover, photoreceptors were obtained in the same manners as in Examples 1 to 3, except that the coating fluids were stored in an environment of 15° C.±5° C. for 100 days and then used to form a photosensitive layer. Each photoreceptor was mounted in a photoreceptor cartridge for color laser printer LP1500C, manufactured by Seiko Epson Corp. This photoreceptor cartridge was mounted in the color laser printer and images were formed. As a result, satisfactory images were obtained.

TABLE 2

| | | | Viscosity change with time | | | |
|---|---|---|---|---|---|---|
| | | | (mPa · s) | | | |
| | | | Immediately | After | After | After |
| | | | after | 7 | 30 | 100 |
| | Resin | Solvent | preparation | days | days | days |
| Example 1 | random | THF/toluene | 445 | 473 | 483 | 517 |
| Example 2 | random | THF/toluene | 390 | 409 | 418 | 440 |
| Example 3 | random | THF/toluene | 331 | 345 | 370 | 378 |
| Example 4 | random | THF/toluene | 156 | 153 | 150 | 164 |
| Example 5 | random | THF/toluene | 265 | 257 | 258 | 275 |
| Example 6 | random | THF/toluene | 232 | 221 | 226 | 242 |
| Example 7 | block | THF/toluene | 470 | — | — | — |
| Example 8 | block | THF/toluene | 390 | — | — | — |
| Example 9 | block | THF/toluene | 350 | 390 | 470 | — |
| Comparative | random | THF/anisole | 503 | 544 | 574 | 617 |
| Example 1 | | | | | | |
| Comparative | random | THF/anisole | 406 | 418 | 453 | 470 |
| Example 2 | | | | | | |
| Comparative | random | THF/anisole | 356 | 363 | 380 | 391 |
| Example 3 | | | | | | |
| Comparative | block | THF/anisole | 510 | 550 | 580 | 620 |
| Example 4 | | | | | | |
| Comparative | block | THF/anisole | 399 | 410 | 441 | 472 |
| Example 5 | | | | | | |
| Comparative | block | THF/anisole | 360 | 362 | 380 | 395 |
| Example 6 | | | | | | |
| Comparative | random | THF/toluene | 380 | 375 | 377 | 375 |
| Example 7 | | | | | | |
| Comparative | block | THF/toluene | 360 | 362 | 366 | 365 |
| Example 8 | | | | | | |

* “—” indicates that viscosity was not measured.

TABLE 3

| | | | Electrical-property | |
|---|---|---|---|---|
| | | | test (after 30 days) | |
| | Resin | Solvent | E½ (mJ/cm²) | VLmax (−V) |
| Example 1 | random | THF/toluene | 0.100 | 42 |
| Example 2 | random | THF/toluene | 0.097 | 40 |
| Example 3 | random | THF/toluene | 0.098 | 43 |
| Example 4 | random | THF/toluene | 0.109 | 85 |
| Example 5 | random | THF/toluene | 0.107 | 83 |
| Example 6 | random | THF/toluene | 0.107 | 82 |
| Comparative | random | THF/anisole | 0.100 | 45 |
| Example 1 | | | | |
| Comparative | random | THF/anisole | 0.098 | 45 |
| Example 2 | | | | |
| Comparative | random | THF/anisole | 0.098 | 48 |
| Example 3 | | | | |
| Comparative | block | THF/anisole | 0.110 | 60 |
| Example 4 | | | | |
| Comparative | block | THF/anisole | 0.107 | 55 |
| Example 5 | | | | |
| Comparative | block | THF/anisole | 0.104 | 53 |
| Example 6 | | | | |
| Comparative | random | THF/toluene | 0.097 | 35 |
| Example 7 | | | | |
| Comparative | block | THF/toluene | 0.098 | 42 |
| Example 8 | | | | |

### Example 10

In 529 parts by weight of a tetrahydrofuran/methylcyclohexane (weight ratio, 8/2) mixed solvent were dissolved 100 parts by weight of the resin produced in Production Example 2, 50 parts by weight of a charge-transporting substance constituted of a composition of geometrical isomers having the structure represented by the formula (3) given above, 8 parts by weight of 3,5-di-t-butyl-4-hydroxytoluene (BHT), and 0.03 parts by weight of a silicone oil as a leveling agent. Thus, a coating fluid for charge-transporting-layer formation was prepared. This coating fluid was stored in an environment having a temperature of 25° C.±5° C. and examined for viscosity change with time during the storage in the same manner as in Example 1.

An electrophotographic photoreceptor was produced in the same manner as in Example 1, except that the coating fluid for charge-transporting-layer formation prepared in this Example was used. The electrophotographic photoreceptor was evaluated in the same manner. The results obtained are shown in Table 4 and Table 5.

### Comparative Example 9

A coating fluid for charge-transporting-layer formation was prepared in the same manner as in Example 10, except that the resin produced in Production Example 5 was used in place of the resin of Production Example 2 used for the charge-transporting layer. However, this coating fluid gelled immediately after preparation. It was hence impossible to conduct a viscosity measurement.

### Example 11

A coating fluid for charge-transporting-layer formation was prepared in the same manner as in Example 2, except that use was made of a resin produced by the method described in the Example 1 of JP-A-2007-126493 (viscosity-average molecular weight, 30,000; average number of repetitions of oligomer A, 3.2). This coating fluid was examined for viscosity in the same manner as in Example 2. An electrophotographic photoreceptor was produced using this coating fluid in the same manner as in Example 1 and examined for electrical properties. The results obtained are shown in Table 4 and Table 5.

TABLE 4

| | | | Viscosity change with time | | | |
|---|---|---|---|---|---|---|
| | | | (mPa · s) | | | |
| | | | Immediately | | After | After |
| | | | after | After 7 | 30 | 100 |
| | Resin | Solvent | preparation | days | days | days |
| Example | random | THF/ | 206 | 210 | 218 | 230 |
| 10 | | methyl- | | | | |
| | | cyclohexane | | | | |
| Example | random | THF/toluene | 385 | 390 | 401 | 419 |
| 11 | | | | | | |

TABLE 5

| | | | Electrical-property | |
|---|---|---|---|---|
| | | | test (after 30 days) | |
| | Resin | Solvent | E½ (mJ/cm²) | VLmax (−V) |
| Example 10 | random | THF/methyl- | 0.098 | 54 |
| | | cyclohexane | | |
| Example 11 | random | THF/toluene | 0.096 | 35 |

It can be seen from the results given above that when coating fluids were obtained by mixing a copolymer resin constituted of the repeating structure represented by formula (1) and a structure different from the repeating structure represented by formula (1) with a solvent having a boiling point of from 80° C. to 150° C., then these coating fluids retained satisfactory fluid stability. Furthermore, the photoreceptors produced using these coating fluids also retained satisfactory electrical properties.

In the case of the THF/anisole mixed solvent, application of the coating fluids resulted in photoreceptor blushing although the coating fluids were stable. Anisole has a lower vapor pressure than toluene. It is therefore necessary for inhibiting sagging during application that anisole should be used in a smaller proportion to THF than toluene. This resulted in a high evaporation rate after application and hence in blushing, although the coating fluids had satisfactory stability. When THF was used alone, photoreceptor blushing after coating-fluid application was observed in this case also.

In the case where resins having no repeating structure represented by formula (1) were used, none of the coating fluids gelled as shown in Comparative Examples 7, 8, and 9. However, the photoreceptors produced using these coating fluids were inferior in wearing resistance to the photoreceptors having the repeating structure represented by formula (1), when used for printing on a printer.

According to the invention, it has become possible to produce a coating fluid excellent in fluid stability and coating property and to produce an electrophotographic photoreceptor and an electrophotographic photoreceptor cartridge using the coating fluid.

While the invention has been described in detail and with reference to specific embodiments thereof, it will be apparent to one skilled in the art that various changes and modifications can be made therein without departing from the spirit and scope thereof. This application is based on a Japanese patent application filed on Feb. 7, 2007 (Application No. 2007-027526), the contents thereof being herein incorporated by reference.

### INDUSTRIAL APPLICABILITY

According to the invention, a coating fluid for electrophotographic-photoreceptor production can be obtained which is excellent in coating property and fluid stability and which enables an electrophotographic photoreceptor having a photosensitive layer formed from the coating fluid to have excellent electrical properties and excellent mechanical durability. Furthermore, an electrophotographic photoreceptor produced using the coating fluid can be obtained.

1. A coating fluid for electrophotographic-photoreceptor production, comprising: a copolycarbonate resin which contains a repeating structure represented by the following formula (1) and does not contain a repeating structure having a biphenyl structure in an amount of 10% by weight or larger, in which the average number of repetition of the formula (1) is 10 or smaller; and a solvent A having a boiling point of from 80° C. to 150° C.:

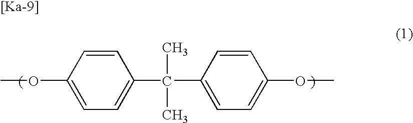

2. A coating fluid for electrophotographic-photoreceptor production, comprising: a copolycarbonate resin which contains a repeating structure represented by the following formula (1) in an amount of 50% by weight or larger, in which the average number of repetition of the formula (1) is 10 or smaller; and a solvent A having a boiling point of from 80° C. to 150° C.:

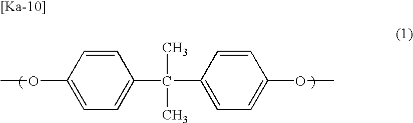

3. The coating fluid for electrophotographic-photoreceptor production according to claim 1 or 2, which further comprises a solvent B having a lower boiling point than the solvent A.

4. The coating fluid for electrophotographic-photoreceptor production according to claim 1 or 2, wherein the solvent A is a hydrocarbon compound.

5. The coating fluid for electrophotographic-photoreceptor production according to claim 1 or 2, wherein the solvent A is an aromatic hydrocarbon compound.

6. The coating fluid for electrophotographic-photoreceptor production according to claim 1 or 2, wherein the solvent A is toluene.

7. The coating fluid for electrophotographic-photoreceptor production according to claim 1 or 2, wherein the copolycarbonate resin is a random copolycarbonate resin.

8. An electrophotographic photoreceptor comprising a conductive base and a photosensitive layer formed from the coating fluid according to claim 1 or 2.

9. An electrophotographic photoreceptor comprising a conductive base and a photosensitive layer, wherein the photosensitive layer comprises: a copolycarbonate resin containing a repeating structure represented by the following formula (1) and not containing a repeating structure having a biphenyl structure in an amount of 10% by weight or larger, in which the average number of repetition of the formula (1) is 10 or smaller; and an aromatic hydrocarbon in an amount of 0.01 mg/cm³ or larger:

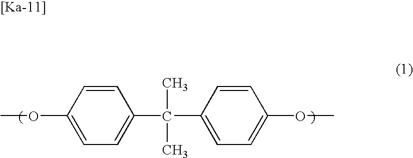

10. An electrophotographic photoreceptor comprising a conductive base and a photosensitive layer, wherein the photosensitive layer comprises: a copolycarbonate resin containing a repeating structure represented by the following formula (1) in an amount of 50% by weight or larger, in which the average number of repetition of the formula (1) is 10 or smaller; and an aromatic hydrocarbon in an amount of 0.01 mg/cm³ or larger.

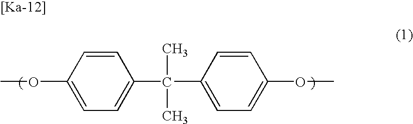

11. An image-forming apparatus comprising: the electrophotographic photoreceptor according to claim 8; a charging device which charges at least the electrophotographic photoreceptor; an imagewise-exposure device which imagewise exposes the charged electrophotographic photoreceptor to a light to form an electrostatic latent image; a development device which develops the electrostatic latent image with a toner; and a transfer device which transfers the toner to a receiving object.

12. An electrophotographic cartridge comprising: the electrophotographic photoreceptor according to claim 8; and at least one member selected from a charging device which charges the electrophotographic photoreceptor, an imagewise-exposure device which imagewise exposes the charged electrophotographic photoreceptor to a light to form an electrostatic latent image, a development device which develops the electrostatic latent image with a toner, and a transfer device which transfers the toner to a receiving object.

13. An image-forming apparatus comprising: the electrophotographic photoreceptor according to claim 9 or 10; a charging device which charges at least the electrophotographic photoreceptor; an imagewise-exposure device which imagewise exposes the charged electrophotographic photoreceptor to a light to form an electrostatic latent image; a development device which develops the electrostatic latent image with a toner; and a transfer device which transfers the toner to a receiving object.

14. An electrophotographic cartridge comprising: the electrophotographic photoreceptor according to claim 9 or 10; and at least one member selected from a charging device which charges the electrophotographic photoreceptor, an imagewise-exposure device which imagewise exposes the charged electrophotographic photoreceptor to a light to form an electrostatic latent image, a development device which develops the electrostatic latent image with a toner, and a transfer device which transfers the toner to a receiving object.
